(19) United States
(12) Patent Application Publication
(10) Pub. No.: US 2025/0060986 A1
(43) Pub. Date: Feb. 20, 2025

(54) AUTOMATIC DIFFERENTIATION AND OPTIMIZATION OF HETEROGENEOUS SIMULATION INTELLIGENCE SYSTEM

(71) Applicant: Pasteur Labs, Inc., Brooklyn, NY (US)

(72) Inventor: Alexander Lavin, Brooklyn, NY (US)

(21) Appl. No.: 18/819,325

(22) Filed: Aug. 29, 2024

Related U.S. Application Data
(63) Continuation of application No. PCT/US2023/017471, filed on Apr. 4, 2023.
(60) Provisional application No. 63/327,145, filed on Apr. 4, 2022.

(51) Int. Cl. G06F 9/455

(52) U.S. Cl. CPC G06F 9/45558; G06F 2009/45591

(57) ABSTRACT

Provided herein are systems and methods comprising one or more virtual machines and a compiler to enable automatic differentiation across a stack. Further provided herein are technologies, integrations, and workflows to allow for automatic differentiation.

### CROSS REFERENCE TO RELATED APPLICATIONS

This application is a continuation application of International Patent Application No. PCT/US2023/017471, filed Apr. 4, 2023, which claims the benefit of U.S. Provisional Application No. 63/327,145, filed Apr. 4, 2022, each of which is hereby incorporated by reference in its entirety.

### BACKGROUND

The main classes of applications driving extreme-scale parallel and distributed computing, and new hardware architectures for domain- or application-specific accelerated computing, e.g., machine learning (ML) and artificial intelligence (AI), data engineering and analysis, and simulation, are becoming highly interdependent, especially in context of data-driven learning systems and science and engineering domains. Therefore, there is a need for the development of systems and methods for automation of software and/or hardware development, including automated or dynamic composition and optimization of heterogeneous components throughout the hardware-software stack. In addition to the exploding complexity of hardware-software stack configurations for a given AI/ML or simulation application, there are information bottlenecks (e.g., vertical boundaries) between the stack abstraction levels that prohibit cross-layer interactions let alone optimizations. These concerns must be addressed with a new, unified system stack purpose-built for AI/ML and simulation workloads.

### SUMMARY

The present disclosure comprises the design and development of a new class of runtime environment that is constructed from first principles for (and with) machine learning (ML) and artificial intelligence (AI). An objective of this runtime environment comprises the integration of modern AI/ML techniques into the operating system itself in order to achieve substantially better performance on a task. This can be made possible when such a system, if presented with a problem, is able to adjust the entire software and/or hardware stack dynamically in such a way that the problem can be solved faster. The optimization is performed in order to run computation for solving that task more efficiently yet reliably.

Examples of such behavior of dynamically adjusting a stack include, but are not limited to, dynamic just-in-time (JIT) program generation, compilation, and evaluation (e.g., program synthesis, solution-space exploration); differentiable components of the runtime system which allow dynamic resource allocation (e.g., memory management, processor allocation, etc.) in such a way that the task is completed faster or in a more efficient way; or integration of the operating system with user application via standard (e.g., a user does not modify anything compared to other systems) and additional API (e.g., a user may inform the OS about their intentions).

Further, a runtime environment of the present disclosure may enable AI algorithms that are currently infeasible. Examples for why some AI algorithms may be infeasible include, but are not limited to, the computational efficiency being magnitudes too large, low-level primitives that do not enable probabilistic reasoning operations, or because valuable information is lost in the abstraction layers of the software-hardware stack.

Ways to overcome such challenges comprises building a novel AI-native OS, where information can be propagated vertically in the software-hardware (SW-HW) stack for AI/ML. As such, disclosed herein is a novel system that implements automatic differentiation (autodiff or AD) up-and-down the full stack to compute, expose, and propagate gradients, errors, etc. Several overarching themes arise in view of such a system comprising autodiff up-and-down the full stack. Such themes include but are not limited to: optimization of arbitrary tasks; gradient-based learning across SW-HW abstraction levels; close-to-the-metal ML and probabilistic reasoning (via probabilistic programming, differentiable programming, and auto-configured DSLs); reliability, such as new dimensions of uncertainty reasoning, new metrics; and optimization for heterogeneous hardware.

In one aspect disclosed herein are systems comprising: one or more virtual machines (VMs) configured to generate a reconfigurable architecture, wherein each of the one or more VMs comprises an abstraction of a computer engine; and a compiler configured to compile software executed on the one or more VMs, wherein the compiler is configured to or is capable of automatic differentiation (autodiff). In some embodiments, the one or more VMs comprises autodiff capabilities. In some embodiments, the autodiff capabilities comprise emitting gradient programs at intermediate representations (IR) and/or at the instruction set. In some embodiments, the one or more VMs are parameterized. In some embodiments, the one or more VMs comprises one or more parameters to be optimized. In some embodiments, the one or more parameters comprises a size of the memory, number and/or width of registers, available instruction set, instruction encoding, implementation of firmware, input/output (I/O), or any combination thereof. In some embodiments, each of the one or more VMs comprise private resources. In some embodiments, the compiler comprises a multi-level intermediate representation (MLIR) compiler or a low-level intermediate representation (LLVM IR) compiler. In some embodiments, the autodiff comprises converting a programming language into machine code processed on heterogeneous hardware. In some embodiments, the compiler enables the use of probabilistic programming, domain specific languages, differentiable programming, or any combination thereof. In some embodiments, the one or more VMs run on a GPU, CPU, FPGA, ASIC, NVMe, microcontroller, AI-accelerator, or any combination thereof. In some embodiments, the AI-accelerator comprise Google-TPU®, Graphcore®, Cerebras®, SambaNova®, or a combination thereof. In some embodiments, about 1000 VMs run on a GPU. In some embodiments, about 10,000 VMs run on a GPU. In some embodiments, about 500 VMs run on a CPU. In some embodiments, each of the one or more VMs is about 100 to about 500 lines of code. In some embodiments, each of the one or more VMs is about 300 lines of code. In some embodiments, the system allows for machine programming across a stack. In some embodiments, the system further comprises a software stack, a hardware stack, or a hardware-software stack. In some embodiments, the software stack, the hardware stack, the hardware-software-stack, or any combination thereof, is differentiable. In some embodiments, the software stack, the hardware stack, the hardware-software stack, or any combination thereof, enables gradient-based learning and/or optimization.

### BRIEF DESCRIPTION OF THE DRAWINGS

A better understanding of the features and advantages of the present subject matter will be obtained by reference to the following detailed description that sets forth illustrative embodiments and the accompanying drawings of which:

FIG. 1 shows a non-limiting example of a block diagram for a system comprising a Sim-AI OS;

FIG. 2 shows a non-limiting example of a block diagram of a Sim-AI OS;

FIG. 3 shows a non-limiting example of the bifurcated space of machine programming;

FIG. 4 shows a non-limiting example of a computer hardware and software structure;

FIG. 5 shows a non-limiting example of a computer architecture;

FIG. 6 shows a non-limiting example of a block diagram of virtual machines with flexible network topology;

FIG. 7 shows anon-limiting example of the flow of gradients in a block diagram of virtual machines with flexible network topology;

FIG. 8 shows a non-limiting example of block diagram of a low-level intermediate representation used by a compiler framework;

FIG. 9 shows a non-limiting example of block diagram with memory contents of a grid of 16 VMs running an 18 byte long program generating a selected pattern;

FIG. 10 shows a non-limiting example of an FPGA floorplan illustrating VMs placed in the programmable logic; and

FIG. 11 schematically illustrates a computer system that is programmed or otherwise configured to implement methods provided herein.

### DETAILED DESCRIPTION

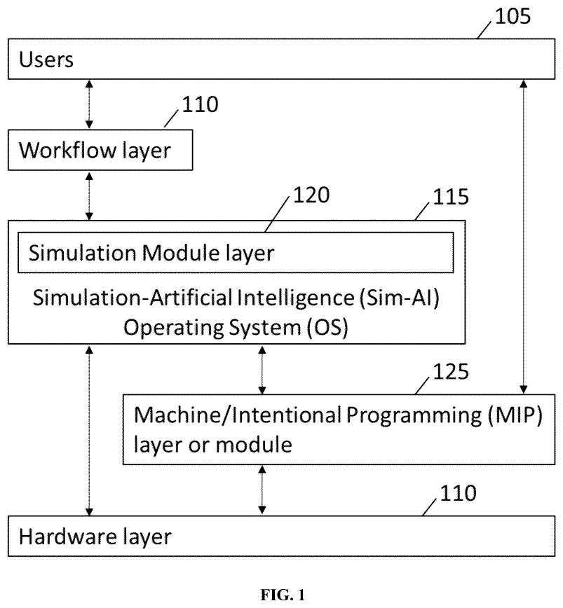

The technology of the present disclosure comprises an ideal area for development and evaluation (as well as future dissemination and education) at the intersection of accelerated (and high-performance) computing, AI, and engineering sciences. The technology comprises use-cases in many important areas of science and engineering, that provide useful yet challenging constraints and diversity for the technologies described herein (and broadly machine programming and AI/ML). As an example, heterogeneous settings are the norm (in both domain and systems types of heterogeneity). And the common ML evaluations and metrics do not suffice in simulation intelligence (SI) environments, where differences such as scientific data and hypothesis-based workflows call for distinct and novel definitions of performance and reliability. Additionally, there can be a flywheel effect by pursuing HW-SW innovations in this way, as the improvement of SI methods with well-architected use-cases can lead to novel compute architectures (and perhaps substrates) that in turn improve the fundamental SI methods and the platforms they are deployed on. In particular, the present disclosure comprises a full-stack autodiff, HW-SW differentiable programming, and AI-native OS (similar to, for example, FIG. 1).

Much like the impact automatic differentiation (and more specifically differentiable programming) has had on the machine learning and scientific computing communities, similar transformations and paradigm shifts can be expected by bringing such capabilities to the broader computation stack. For instance, deep learning, the renaissance of machine learning this century, may not be possible without autodiff and differentiable programming. As such the advances and technologies described herein can have a transformative effect on science and engineering processes.

The advantages of MP, full hardware-software stack gradient-based learning, and OS-level autodiff (amongst others) can not only provide magnitudes acceleration for existing computational workflows, but further enable practitioners to consider problems and challenges from completely new perspectives. With MP and DP as core elements (“motifs”) of the new simulation intelligence (SI) paradigm, MP and DP can be expected to play critical roles in shaping the SI stack (e.g., FIG. 1) and the subsequent reshaping of scientific methods en route to Nobel-Turing breakthroughs.

In some embodiments, the technology of the present disclosure can be used with a Simulation-AI Operation System (Sim-AI OS) and its accompanying workflows and dataflows. In some cases, Sim-AI OS can be used interchangeably with Simulation Intelligence Operating System (SIOS). In some cases, the Sim-AI OS and its accompanying workflows and dataflows can be purpose-built for Simulation Intelligence, general purpose for use across domains for science and intelligence, or both. In some cases, the system of the present disclosure enables optimal, efficient, and novel workflows for several user-groups in fields including, but not limited to, engineering, sciences, and intelligence.

### Machine Programming (MP)

The systems of the present disclosure comprise machine programming (MP) in order to dynamically and efficiently compose a hardware-software stack of elements that can be highly heterogeneous, combining myriad types of hardware accelerators, computing architectures (up to peta- and exascale), various programming languages, and mixed data types. As an example, MP comprises integral component (or rather “motif”) of the new field of simulation intelligence (SI) (e.g., the merger of AI/ML, simulation, and scientific computing in new, synergistic ways). The main classes of applications driving extreme-scale parallel and distributed computing—machine learning, data analysis, and simulation—are becoming highly interdependent, and in complex ways across essentially all domains, not unlike SI. In one aspect, a significant feature of SI that makes the systems described herein relevant for scalable computing and engineering sciences comprises the manifestation of SI suggests a rethinking of the software-hardware stack (FIG. 1). In another aspect, a significant feature of SI that makes the systems described herein relevant for scalable computing and engineering sciences comprises its applicability across domains of science, engineering, and society.

A real-world application that are applicable to the system of the present disclosure can comprise several factors. In some instances, it may be similar enough to utilize the same research methods build herein. In some instances, it may be distinct in specific ways that force the research methods to generalize (for example, different applications shall impose distinct requirements for deployment setting, hardware heterogeneity, data types and sizes, time and space efficiency requirements, etc.). In some instances, apart from the technological advances in MP etc., the scientific results may be significant for the given field. As an example, accelerating a coastal climate simulator 1000× such that real-time (sub 10-minutes) disaster preparedness is possible, and scientists can iterate over experiments magnitudes more quickly to ask never-before-possible questions). In some instances, SI can be leveraged to make further interdisciplinary advances. As an example, the ability to not only integrate multiple scaling operations of a computational science workflow (such as material design, synthesis, validation, and production) but to also learn and self-improve because gradient-based algorithms can run various optimizations that are currently unthinkable because information can't propagate in existing workflows, full stop).

MP generally comprises a new paradigm of computing research, towards the automation of software and/or hardware development. From the perspective of simulation in science and engineering, systems will soon, if not already necessitate automating aspects of software development, especially when considering data-driven learning systems. Thus MP is a motif of Simulation Intelligence (SI). With MP in the SI operating system (FIG. 1), as a motif that interfaces hardware and software, the integration of SI motifs can become far more efficient (e.g., auto HW-SW optimizations and codesign), robust (e.g., less prone to human and stochastic errors), and scalable (e.g., flexibly deployable modules from HPC to the edge).

As illustrated in FIG. 1, MP can understand code across motifs, compose them into working systems, and then optimize these systems to execute on the underlying hardware. Hence, while MP may not be tied to any specific class of SI problems, MP will be integral as the glue that ties the other SI motifs together, serving as a bridge to the hardware. MP, with the novel vertical integration and differentiability described herein, can further propagate valuable uncertainties, as well as error and/or reliability metrics between hardware and software layers. Further, the information surfaced from such MP integrations can surface valuable hardware-software insights. As an example, a valuable hardware-software insight can include providing full-stack gradient data that can be used for inverse design of new computational architectures, as well as substrates.

Without MP running in a cohesive and/or holistic, full-stack manner, bottom-up constraints can be encountered on the types of data structures and algorithms implemented above the hardware layers. As an example, this is not unlike a “hardware lottery”, where a research idea or technology succeeds and trumps others because it is suited to the available software and hardware, not necessarily because it is superior to alternative directions. As such, this “hardware lottery” is decisive in the paths pursued by the largely disconnected hardware, systems, and algorithms communities. As a further example, the past decade has provided an industry-shaping example of deep learning and GPUs. However, the various mechanisms of MP can provide flexible use of heterogeneous software components, as well as can provide ample opportunity to mitigate such hardware lottery effects for SI, and broadly in AI and software fields.

Provided herein are systems and methods to provide outcomes with SI applications that each
(a) integrate multiple AI/ML methods, (b) enable simulation with multiple types of real-world data, (c) enable scientific computing in interdisciplinary settings, (d) exploit the more challenging and/or scientifically promising components of the hardware-software stack, such as close-to-the-metal domain-specific languages, multi-language compilers, heterogeneous hardware, and others, or any combination thereof.

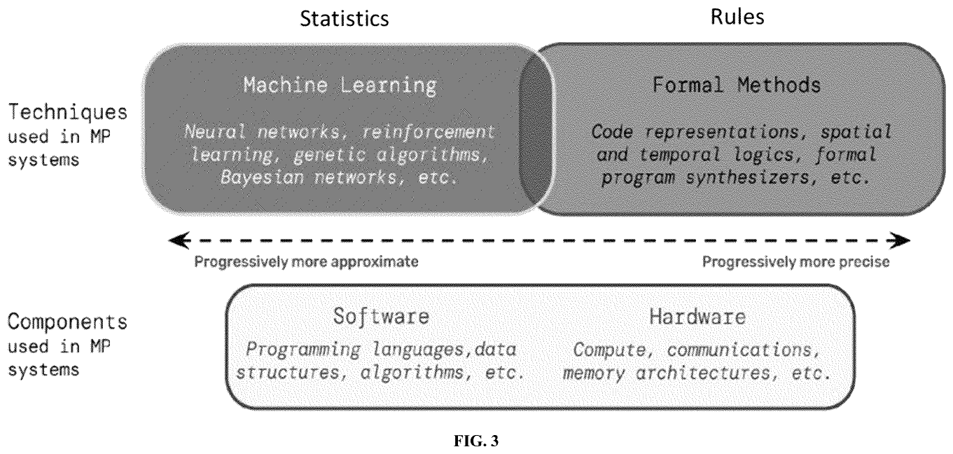

In order to approach challenges associated with the various mechanisms of MP in a collective and reproducible way, an open benchmarks for MP can be required. In some instances, much like areas of the ML community such as computer vision and natural language processing. However, in some instances, producing quality benchmarks MP can be more challenging. Such reasons include, but are not limited to: (a) the precise differences between computing components in one setting versus another directly influence evaluation results (e.g., in ways that are less relevant in computer vision or NLP, where a 4-GPU instance with Amazon® in Virginia is equivalent to a 4-GPU instance with Microsoft® in London), (b) any problem-specific evaluation methods are often useful (e.g., rather than a one-size-fits-all dataset), and (c) techniques are not always comparable as many fall on the spectrum of ML-to-formal methods (e.g., FIG. 3).

Provided herein, in some instances, is a MP benchmark that establishes a principled, efficient, understandable testing ground that can help coordinate and advance the field. As an example, this is not unlike an “ImageNet moment” for computer vision a decade ago. However, in some instances, care is taken to avoid the inherent limitations, errors, and biases (e.g., such as those present in ImageNet). As a further example, it is undesirable for a specific dataset or narrow problem in a field to consequently mold how a field is defined.

The MP developments and applications provided herein aim to demonstrate increases in productivity of scientific programming by orders of magnitude. In some instances, this is accomplished by making more/all parts of the software lifecycle more efficient, including, but not limited to reducing the time spent tracking down software quality defects, such as those concerned with correctness, performance, security, and portability. In some instances, MP can enable scientists, engineers, technicians, and students to produce and maintain high quality software as part of their problem-solving process without requiring specialized software development skills (which today can create choke points in organizations of researchers and engineers in many disconnected capacities).

MP enables technologies that can understand code across programming languages and/or model types. MP can further auto-compose programming languages and/or model types into working systems, and can optimize these systems to execute on the underlying hardware. In some instances, the underlying hardware is homogeneous. In some instances, the underlying hardware is heterogeneous. While some forms of intentional communication from humans to machines are emerging (e.g., translation from natural language to programming language and translation of visual diagrams to software programs, such as GitHub's Co-Pilot®, or automated synthesis of code for visual diagrams), the extent of MP capabilities can be realized with the software-hardware full-stack differentiability. In some instances, this is especially true for general-purpose use and deployment with heterogeneous systems.

The current state of the MP field applies machine learning techniques (e.g., deep learning) to learn a high-dimensional mapping between code inputs and outputs. In some examples, this includes learning models to automate software debugging (e.g., in controlled spaces that are comprehensively covered by the given datasets). In such examples, this automation is accomplished in part by gradient-based learning over software programming datasets. By comparison, full-stack automatic differentiation as provided herein can enable another dimension of MP. This includes making the stack itself differentiable. In some instances, making the stack differentiable enables gradient-based learning at multiple abstraction levels across the full software-hardware stack (e.g., rather than isolated to one specific layer or component of the stack). In some instances, making the stack differentiable in turn allows for learning models of resource allocation and other stack operations that are manually, suboptimal, and error-prone (e.g., referred to as MP2). In some instances, even proof-of-concept demonstrations of MP2 have substantial significance computing systems broadly and/or a highly efficient SI stack (e.g., FIG. 1). In some instances, this is also the case in AI/ML.

### Simulation-AI (Sim-AI) Operating System (OS)

The machine programming and/or autodiff capabilities of the present disclosure can exist within a software-hardware stack framework comprising an operating system (OS) and surrounding technologies that are purpose-built for Simulation Intelligence (e.g., FIG. 1). In some instances, the OS and surrounding technologies are also general purpose for science and intelligence workflows across domains. Referring to FIG. 1 is an example of a block diagram for a system comprising a simulation-AI (Sim-AI) operating system (OS). The system may comprise an simulation intelligent (SI) stack, which may enable optimal, efficient, and novel workflows for several user-groups 105 in engineering, sciences, and intelligence. Users 105 may generally comprise scientists and other researchers in across many domains and across scales (e.g., from particle physics and biology, to material design and drug discovery, to weather and climate science, to socioeconomics and geopolitics, to astrophysics and cosmology), such as, but not limited to, ML/AI scientists and engineers, data scientists, theoreticians, robotic, AI, and automated scientists (or “self-driving laboratories”), intelligence analysts, economists and political scientists, or other domain experts, including policy- and decision-makers (from climate to economics to financial/trading markets). In some embodiments, the SI stack, as illustrated in FIG. 1, may comprise modules and interfaces for users 105 to interact at various abstraction levels, such as programmatic and user-friendly interfaces for the top-level workflows 110, the low-level machine programming interfaces and modules 125, flexible and configurable ML and data modules 115.

In some embodiments, the SI stack may comprise a computing and data infrastructure with one or more layers including: a workflow layer 110 (e.g., applications), a simulation-artificial intelligence (Sim-AI) operating system (OS) 115 (e.g., simulation module layer 120), machine/intentional programming (MIP) layer 125, and hardware layer 130 (e.g., compute substrate, such as CPU, GPU, FPGA, etc.). In some cases, the Sim-AI OS 115 may comprise one or more engines (e.g., techniques and/or methods). In some cases, the MIP layer 125 may be any programming interface (e.g., manual or machine programming).

The Sim-AI OS 115 may comprise one or more classes of complementary algorithmic methods that represent foundational techniques for synergistic simulation and AI technologies. In some cases, the workflow layer 110 may comprise one or more Sim-AI workflows (e.g., applications), which may be the result of the integration with the Sim-AI OS 115. In some instances, the workflow layer 110 may reciprocate information, feedback, and data that informs the development and implementation of Sim-AI OS 115. In some instances, the workflow layer 110 may comprise new scientific and intelligence workflows, such as, but not limited to, automation and human-machine teaming processes (e.g., “active sciencing”, inverse problem solving, etc.). The manifestations of the Sim-AI OS 115 and the SI stack of FIG. 1 may comprise modular and versatile software packages, which as-is can supply the structured layers for the workflows described herein, while also providing a user with flexibility and extensibility to build atop of, and/or swap in custom components.

Further, the information flow illustrated in FIG. 1 may not be first-order or mutually exclusive. There may any number of variations of information flow in the SI stack of FIG. 1. That is FIG. 1 may represent a general scheme of which there can be numerous variations that may combine methods towards similar information flows and workflows. As an example, a ML researcher may implement pipelines that traverse multiple layers (and information paths). As a further example, if a user who is an engineer is working with machine programming, that engineer may also work with Sim-AI OS methods simultaneously or sequentially.

The SI stack of FIG. 1 may also provide for interfacing and complete pluggability of third party, proprietary, open-source, open-standard, custom, or other types of extensions. Extensions may comprise, by way of non-limiting example, additional machine learning libraries, hardware-software codesigns, software development kits (SDKs), application programmable interfaces (APIs), computation distribution, privacy-preserving algorithms and data pipelines, etc.

A set of technology capabilities, enabled by the present disclosure, which may help scientific endeavors and fields beyond simulation-, intelligence-, and data-related bottlenecks, may include, by way of non-limiting example:
Synergistically combine expert knowledge models (e.g., first principles, mechanistic equations) with data-driven surrogate models
Flexibly combine multiple engines/simulators
Efficient and scalable simulators, operating at multiple levels of fidelity and abstraction
Simulate and learn processes and systems spanning multiple physics and multiple spatial-temporal scales
Capable/reliable simulation and inference with limited data
Validate simulations with real data, and quantify reliability (e.g., uncertainty)
Learn models that reflect the probabilistic causal structures of complex systems
Readily encode domain expertise and causal structure into simulators
Generate counterfactual simulations (e.g., grounded in causality theory) that reliably simulate possible futures over large time scales and high-dimensional, multimodal data
Inverse problem solving in otherwise intractable spaces and domains
Accelerate existing simulators by multiple magnitudes without refactoring or rewriting legacy codebases
Spin up a simulator via direct physical analogy
Provide a catalogue of domain-specific engines and workflows (e.g., for non-ML-experts)
Integrate seamlessly with real-world datasets, and online data streams
Data engineering to ensure reliability, reproducibility, and security
Systems AI systems engineering and uncertainty reasoning for complex, dynamic combinations of data, software, hardware, and people

The Sim-AI OS 115 may comprise a simulation module layer 120 that may enable one or more workflows described herein. The simulation module layer 120 may make use of the accelerated computing building blocks in the hardware layer 130. In some embodiments, the simulation module layer may comprise causal computation (e.g., causal ML), agent-based modeling, open-endedness, working memory, domain specific language (DSL) (e.g., SI DSL for probabilistic simulations), semi-mechanical modeling, surrogate modeling and emulation, multi-physics modeling, multi-scale modeling (e.g., spatial and temporal), and simulation-based inference. In some cases, the Sim-AI modules may be combined with other simulation methods and applications (e.g., computational fluid dynamics (CFD), finite element analysis (FEA) solvers, etc.). In further cases, the Sim-AI modules may be integrated with existing machine learning frameworks and tools (e.g., PyTorch® and TensorFlow® libraries for tensor modeling and autodiff).

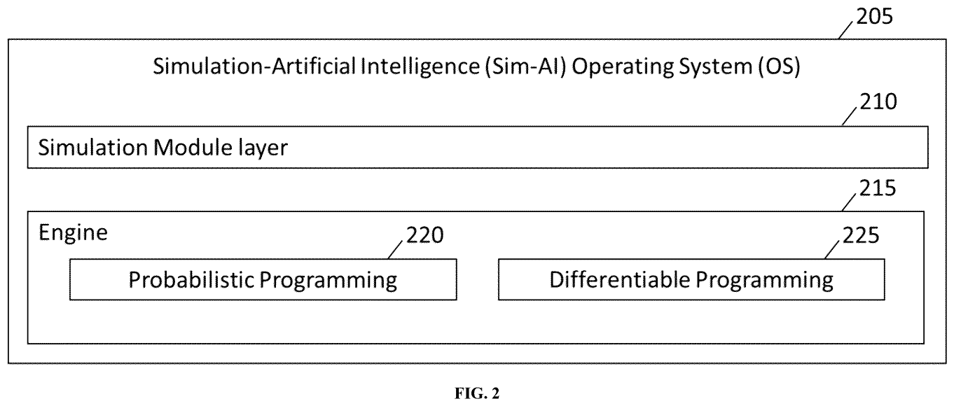

Referring to FIG. 2, the modules in the simulation module layer 220 of the Sim-AI OS 205, may be built using an engine 215 (e.g., techniques and/or methods). In some embodiments, the engine 215 may comprise a probabilistic programming 220 framework, differentiable programming 225 framework, or a combination thereof. In some embodiments, the two frameworks referred to herein may comprise overlaps or interconnections (e.g., probabilistic programming languages can use the auto differentiation mechanisms in differentiable programming).

In some embodiments, the engine 215 may comprise a probabilistic programming 220 framework. Probabilistic programming may be used to expand the scope of probabilistic graphical models (PGM) by allowing for inference over arbitrary models as programs (e.g., programming constructs such as recursion and stochastic branching). Probabilistic programming may enable generative models to be easily written and experimented with. In some cases, the probabilistic programming (PP) paradigm may equate probabilistic generative models with executable programs. Probabilistic programming languages (PPL) can enable practitioners to leverage the power of programming languages to create rich and complex models, while relying on a built-in inference backend to operate on any model written in the language. This decoupling may be a powerful abstraction because it can allow practitioners to rapidly iterate over models and experiments, in prototyping through deployment. The programs may be generative models, since they can relate unobservable causes to observable data, to simulate how we believe data is created in the real world.

Analogously, differentiable programming is a generalization of neural networks and deep learning, allowing for gradient-based optimization of arbitrarily parameterized program modules.

These can provide a much more expressive toolkit of knowledge representation.

As an example, in a probabilistic program, a joint distribution p(x, y) of latent (unobserved) variables x and observable variables y may be defined. PPL inference engines may produce posterior distributions over unobserved variables given the observed variables or data, p(x|y)=p(y|x)p(x)/p(y). As observed variables can correspond to the output of a program, probabilistic programming may provide a way to “invert” a given program, meaning it may infer a program's inputs given an instance of data that corresponds to the program's output. This may be in contrast to a standard program which may take an input to generate a corresponding output.

In some embodiments, probabilistic programs may be used as simulators. In some cases, a probabilistic program may itself be a simulator, as it can express a stochastic generative model of data. In such cases, given a system or process sufficiently described in a PPL, the forward execution of the program can produce simulated data. In some examples, a simulator can be run forward to predict the future, yet with a probabilistic program parameters may be inferred based on the outcomes that are observed. As an example, a neurodegeneration program may define a statistical model with random samplings, from which probabilistic disease trajectories may be generated and parameters may be inferred for individual biomarkers. Further, simulating with probabilistic programs can, for semi-mechanistic modeling, where Turing-complete PPL can provide flexible modeling for integrating physical laws or mechanistic equations describing a system with data-driven components that may be conditioned or trained on data observations. In some instances, PPL may enable semi-parametric modeling, where an inference engine can handle programs that combine parametric and nonparametric models. In such instances, the parametric component may learn a fixed number of parameters and may allow a user to specify domain knowledge, while a nonparametric model (e.g., a Gaussian process) can learn an unbounded number of parameters that grows with the training data. These two programming features—semi-mechanistic and semi-parametric modeling—along with the overall expressiveness of PPL may be well-suited for non-ML specialists to readily build and experiment with probabilistic reasoning algorithms.

In some examples, PPL and DP may be used for “partially specified” models, which comprise black-box (e.g., deep learning) and fully-specified simulators. In further examples, PPL may be advanced and scaled in simulation-based inference. This may be the case particularly in the context of human-machine inference. Using probabilistic programs as the simulator may provide advantages, such as, but not limited to, modularity in modeling systems, general-purpose inference engines, uncertainty quantification and propagation, and interpretability.

In some embodiments, the engine 215 may comprise a differentiable programming 225 framework. Differentiable programming (DP) may comprise a programming paradigm in which derivatives of a program can automatically be computed and used in gradient-based optimization in order to tune the program to achieve a given objective. DP may be used in a wide variety of areas, such as scientific computing and ML. In some embodiments, DP can be viewed as a generalization of deep learning. In some cases, the potential of DP may be immense when taken beyond deep learning to the general case of complex programs. In some instances, existing programs may take advantage of an extensive amount of knowledge embedded within them. In some instances, this may enable novel models to be produced and in silico experiments to be conducted.

In some examples, DP tied to ML and simulation may be used to derive techniques for working with non-differentiable functions like ReLU used in deep learning or with non-smooth functions. It some examples, it may also be useful to work with approximate reals, rather than reals, and to seek numerical accuracy theorems. In further examples, particularly in ML, it may be important for DP to add explicit tensor (multi-dimensional array) types with accompanying shape analysis. Further, richer DP languages may support wide ranges of types and computations (e.g., recursion, or programming with Riemannian manifolds (to accommodate natural gradient descent)). In some instances, Julia, C++(e.g., DiffTaichi®), and close-to-the-metal domain-specific languages may be used to make computation runtimes magnitudes more efficient.

Referring to FIG. 1, the Sim-AI OS layer 115 may be communicably coupled to the workflow layer 110. In some embodiments, the modules and engines of the Sim-AI OS layer 115 may enable one or more workflows (or applications) of the workflow layer 115. In some embodiments, the workflow layer 115 are enabled by one or more modules of the Sim-AI OS. In some embodiments, the workflow layer may comprise inverse design (also referred to as inverse problem solving), open-ended optimization, continual learning, causal inference and discovery, simulator inversion, human machine inference (also referred to as active science), uncertainty reasoning, counterfactual reasoning, digital twins (e.g., with live data), multi-modal simulation, and/or physics-informed learning. In some examples, a workflow may comprise online and dynamic optimization.

In some embodiments, the pathway between users 105, such as scientists and domain experts, and the workflow layer 110 may comprise valuable for practical use. For example, for AI and ML scientists and engineers, this can be a critical path for developing and utilizing the Sim-AI OS 115 and workflow layer 110. The users 105 may further comprise many expertise and interest areas, where users may interact with any layer and component (e.g., software infrastructure engineers working directly with HPC at the lower hardware level, ML scientists working directly on probabilistic programming or open-endedness without the context of a workflow, etc.).

In the present disclosure, the Sim-AI OS modules may comprise significant and valuable overlap between one another. Such overlap provides a valuable framework for integrating such modules. Non-limiting examples of integration of modules may comprise the use of multi-scale and agent-based modeling (e.g., in systems biology, sociopolitics, etc.), the use of physics-infused ML for building surrogate models in multi-physics scenarios, using simulation-based causal discovery in agent-based network models, or semi-mechanistic methods implemented for multiphysics modeling. In some embodiments, one or more elements of the simulation module layer 210 may be combined with one or more elements of the engine 215. In some embodiments, the SI stack of the present disclosure comprises a purpose-build framework for integrating the motifs (e.g., modules or engines) described herein. Table 1 provides a non-exhaustive look of the domains for use-inspired research per motif with various methods and use-cases arise from the integrations of motifs.

TABLE 1

| | | | | Multi- | | | | | |
|---|---|---|---|---|---|---|---|---|---|
| | | | | physics | Simulation- | Surrogate | | Agent- | Open- |
| | Machine | Differentiable | Probabilistic | multi- | based | modeling, | Causal | based | ended- |
| | programming | programming | programming | scale | inference | emulation | reasoning | modeling | ness |
| HEPhysics—theoretical | — | ✓ | ✓ | ✓ | ✓ | — | ✓ | — | ✓ |
| HEPhysics—experimental | ✓ | ✓ | ✓ | ✓ | ✓ | ✓ | ✓ | — | — |
| Complexity | — | — | — | ✓ | — | — | ✓ | ✓ | ✓ |
| Synthetic biology | ✓ | ✓ | ✓ | ✓ | ✓ | ✓ | ✓ | — | — |
| Chemistry | — | ✓ | ✓ | ✓ | ✓ | ✓ | — | — | — |
| Materials | — | ✓ | ✓ | ✓ | ✓ | ✓ | — | — | — |
| Medicine | — | ✓ | ✓ | ✓ | ✓ | ✓ | ✓ | — | — |
| Systems biology | — | ✓ | ✓ | ✓ | — | ✓ | ✓ | ✓ | ✓ |
| Neuro and Cog sciences | ✓ | ✓ | ✓ | ✓ | ✓ | ✓ | ✓ | ✓ | ✓ |
| Energy—nuclear | — | ✓ | ✓ | ✓ | ✓ | ✓ | — | — | ✓ |
| fission & fusion | | | | | | | | | |
| Energy—materials & | — | ✓ | ✓ | ✓ | ✓ | ✓ | — | — | ✓ |
| storage | | | | | | | | | |
| Manufacturing | ✓ | ✓ | — | ✓ | — | ✓ | — | — | ✓ |
| Energy systems | — | — | — | ✓ | — | ✓ | ✓ | ✓ | ✓ |
| Transportation & | — | — | — | ✓ | — | ✓ | ✓ | ✓ | ✓ |
| infrastructure | | | | | | | | | |
| Agriculture | — | ✓ | — | ✓ | — | ✓ | ✓ | ✓ | ✓ |
| Ecology | — | ✓ | ✓ | ✓ | ✓ | ✓ | ✓ | ✓ | ✓ |
| Socioeconomics & | — | ✓ | — | ✓ | — | — | ✓ | ✓ | ✓ |
| markets | | | | | | | | | |
| Finance | ✓ | ✓ | ✓ | — | — | — | ✓ | ✓ | ✓ |
| Geopolitics | — | — | — | ✓ | — | — | ✓ | ✓ | ✓ |
| Defense | ✓ | ✓ | ✓ | ✓ | ✓ | ✓ | ✓ | ✓ | ✓ |
| Climate | — | ✓ | — | ✓ | ✓ | ✓ | ✓ | ✓ | ✓ |
| Earth systems | — | ✓ | — | ✓ | ✓ | ✓ | ✓ | ✓ | ✓ |
| Astrophysics & | — | ✓ | ✓ | ✓ | ✓ | ✓ | ✓ | — | ✓ |
| cosmology | | | | | | | | | |

Referring to FIG. 1, implementations of the Sim-AI OS modules and engine components 115, such as those described herein, can take advantage of available computing resources while also informing the design of new computing architectures. In some embodiments, the Sim-AI OS 115, as well as a MIP layer 125 may be communicably coupled to a hardware layer 130 to enable SI as described herein. In some cases, the SI stack may comprise one or more hardware layers. In some embodiments, the Sim-AI pipelines described herein can be implemented at scale on high performance computers (HPC) and supercomputers, on a simple 4-CPU laptop, anything in between, or a combinations thereof. In some embodiments, the Sim-AI pipelines can be implemented on a centralized network, a decentralized network, a distributed network, or a combination thereof. In some cases, the network may comprise a cloud comprising one or more servers.

In some embodiments, the hardware interfacing layer (e.g., machine/intentional programming 125 and DSL) can add a useful abstraction between low-level computer hardware and other layers, modules, and users. In such embodiments, information can flow between layers, modules, and users, and generate programs and/or compute-optimized code to be run on the hardware 130 below. In some embodiments, a user 105 (e.g., scientist, engineer, analyst, domain experts, etc.) can readily develop and interact with low-level (or close-to-the-metal) code via MIP 125 and DSL. In some cases, an output from machine programming may also communicate information (e.g., logs, feedback, etc.) to the user 105.

In some cases, user software, system software and underlying compute substrate may be integrated through MIP layer 125. In some instances, the SI stack may further comprise a hardware abstraction layer. In some examples, the hardware abstraction layer may perform just-in-time (JIT) compilation and integrate MP methods into the compiler, as well as the runtime. In such instances, the Sim-AI OS 115 may provide OS-level performance estimation, dynamic AI-driven CPU/Task allocation, data-driven scheduling, memory management as well as cache policy and networking.

The machine programming or machine intentional programming (MIP) 125 layer described herein may allow for expanding artificial intelligence. Machine programming (MP) may generally comprise automation of software (and hardware). A MIP system as describes herein, may comprise a system that may automate some or all of the operations of turning the user's intent into an executable program and maintaining that program over time. The present MIP implementations may be uniquely suited for the Sim-AI OS and the scientific workflows. These may be distinct from mainstream ML workflows in ways, such as, significantly affecting data flows, results and/or end-user behaviors. Further, in addition to Sim-AI OS accelerating science and intelligence workflows, MIP can further reduce development time by a degree of automation to reduce the cost of producing secure, correct, and efficient software. These systems can also enable non-programmers to harness the full power of modern computing platforms to solve complex problems correctly and efficiently.

In some embodiments, MP can be reasoned about across three distinct pillars: (i) intention, (ii) invention, and (iii) adaptation. Intention may comprise identifying novel ways and simplifying existing ways for users to express their ideas to a machine. It may also comprise lifting meaning (e.g., semantics) from existing software. Invention may comprise higher-order algorithms and data structures that can fulfill a user's intention. In some cases, inventive systems may simply fuse existing components together to form a novel solution that fulfills the user's intent. Adaptation may comprise taking an invented high-order program and adapting it appropriately to a specific hardware and software ecosystem. This may be done to ensure certain quality characteristics are maintained such as correctness, performance, security, and/or maintainability.

In some embodiments, the hardware layer 130 may be communicably coupled to the MIP layer 125. In some cases, a substrate for compute may comprise commodity hardware (e.g., laptop), using prebuilt libraries (e.g., BLAS), providing one-way interaction upwards. In alternative cases, a substrate for compute may comprise HPC-grade (e.g., 1PF/s CPU, GPU, etc.), which may be bidirectional interaction. In some instances, standard HPC software (e.g., for quantum computing) can be used with the additional injection of Machine Programming (MP) for developing custom new software. In further cases, a substrate for compute may comprise specialized hardware (e.g., FPGA, ASIC, or others dynamically reconfigurable hardware, etc.), which can also provide bidirectional interaction. As an example, a simulation model for a CPU may be built and used to create a model, existing compute blocks (functions, instructions) may be selected, and new functions may be defined through MP. In some embodiments, computation may require considerations, including, but not limited to:
Will advances in the motifs lead to new breeds of algorithms that require radically new systems and/or architectures?Perhaps these can be implemented as ASICs (Application Specific Integrated Circuits), or will new substrates be useful?
Will SI inverse design produce novel compute architectures and substrates?
How will the open-endedness paradigm affect computing systems (memory allocation, load balancing, caching, etc.)?
How will Machine Programming influence hardware-software co-design for simulation intelligence (and high-performance computing)?
In addition to the goals of performance and scalability (e.g., latency, throughput, etc.), energy efficiency, and reliability, how will the advancing technologies build abstractions to facilitate reasoning about correctness, security, and privacy?
Will SI-based surrogate modeling enable a landscape shift where computationally lightweight surrogates running on a small number of GPUs replace massive supercomputing workloads (particularly in physical and life sciences simulations)?What will be the metrics and benchmarks to quantify the tradeoffs between such orthogonal computation approaches?

Further, in some embodiments, distributed training algorithms in HPC platforms may be used to benchmark with idealized neural network models and datasets. However, in some cases, benchmarking may not impart insights regarding the actual performance of these approaches in real deployment scenarios. Such cases may include, but may not be limited to when using domain-inspired AI architectures and optimization schemes for data-driven discovery in the context of realistic datasets, which can be noisy, incomplete, and heterogeneous.

Further, physical computation involved in the simulation-AI methods, models, and/or simulations described herein may incorporate optimizing the design of sensors and chips, and learning NNs with physical components. In some embodiments, ML-enabled intelligent sensor design can be used in inverse design and related machine learning techniques to optimally design data acquisition hardware with respect to a user-defined cost function or design constraint. In some cases, such process may comprise:
1. Standard engineering practices produce an initial design α₀, or a randomized initialization α of parameters and spatial configuration (e.g., in terms of transduction elements or sensing components).
2. Acquisition of raw sensing data Xᵢ, yᵢ from the initial u, and data preprocessing and transformations to Xᵢ′ amenable to machine learning (e.g., normalized, Gaussian noise, etc.).
3. Train a ML model (e.g., NN, GP, etc.) to output sensing results as ŷᵢ.
4. A cost function J(yᵢ, ŷᵢ) is used to evaluate the learned model, using the ground-truth sensing information, yᵢ. In some cases, it may be useful to develop problem-specific cost function with physics-informed constraints (e.g., in multi-physics models).
5. The results from step ( ) inform a redesign αᵢ+1, which, in some cases can eliminate non-informative or less useful features. In some cases, this step can also replace such features with adjustments thereof or alternative sensing elements. In some instances, Bayesian optimization (BO) outer-loop can be used to inform the subsequent design, where the learned NN or GP can serve as the surrogate (e.g., in surrogate modeling). In some instances, BO-based NAS methods may also be applied to sensor components and modules.
6. Repeat from step ( ) for i=0, . . . , N, where termination conditions may be the number of budgeted cycles, convergence on design or outcome, or achieving a down-stream cost function. Depending on the surrogate model choice and optimization scheme, it may be useful to employ transfer learning techniques to reduce the data burden of subsequent iterations.

In some embodiments, such an approach or certain operations in the process described above can improve the overall performance of a sensor and broader data ingestion/modeling system. In some cases, the overall performance may improve with non-intuitive design choices. As an example, in the field of synthetic biology, a surrogate-based design framework with a neural network trained on RNA sequence-to-function mappings may be designed in order to intelligently design RNA sequences that synthesize and execute a specific molecular sensing task. This can result in an in silico design framework for engineering RNA molecules as programmable response elements to target proteins and small molecules. In such an example, the data-driven approach may outperform prediction accuracy resulting from standard thermodynamic and kinetic modeling. In some cases, data-driven, ML-based sensor designs can outperform “intuitive” designs that may be solely based on analytical/theoretical modeling. In some instances, there can be non-trivial limitations, such as large, well-characterized training datasets may be useful to engineer and select sensing features that can statistically separate out various inherent noise terms or artifacts from the target signals of interest. In some further instances, a limitation may comprise the curse of dimensionality, where the high-dimensional space of training data may drown-out the meaningful correlations to the target sensing information.

Automating and optimizing the various processes may also comprise designing, fabricating, and validating computer chips (e.g., ML-based chip design). In some embodiments, ML-based chip design may comprise ML-based “chip floorplanning”, or designing the physical layout of a computer chip. In some cases, this process may comprise placing hypergraphs of circuit components (e.g., macros (memory components) and standard cells (logic gates, e.g., NAND, NOR, XOR, etc.)) onto chip canvases (e.g., two-dimensional grids) so that performance metrics (e.g., power consumption, timing, area, and wire length) can be optimized, while adhering to hard constraints on density and routing congestion. In some embodiments, ML-based chip design may comprise developing a reinforcement learning (RL) approach by framing the task as a sequential Markov decision process (MDP). In some cases, the process may comprise:
States: hypergraph (as an adjacency matrix), node features (width, height, type), edge features (number of connections), current node (macro) to be placed, and metadata of the netlist graph (routing allocations, total number of wires, macros and standard cell clusters).
Actions: all possible locations (grid cells of the chip canvas) onto which the current macro can be placed subject to predefined hard constraints on density or blockages.
Transitions: probability distribution over next states, given a state and an action.
Rewards: always zero but for the last action, where the reward is a negative weighted sum of pro13 wirelength, congestion, and density.

In some cases, graph convolutional NN can be used to learn feature embeddings of the macros and other hypergraph components. In some instances, this architecture may provide advantageous geometric properties for this design space. The benchmark results of this approach can show the generation of chip floorplans that can be comparable or superior to human experts in under six hours, compared to multiple months of manual human effort. This is may allow for AI-driven knowledge expansion, where artificial agents can approach the problem with chip placement experience that may be magnitudes greater in size and diversity than any human expert.

In further embodiments, the process of computer chip development may comprise automation and human-machine teaming. In some cases, this can potentially optimize and accelerate the process, including additional ways simulation-AI can advance chip design. In some instances, the SimNet platform of NN-solvers can be been applied to the problem of design optimization of an FPGAheat sink, which is a multi-physics problem that can be approached with multiple parallel ML surrogates (e.g., with one NN for the flow field and another NN for the temperature field).

### Computer Architecture

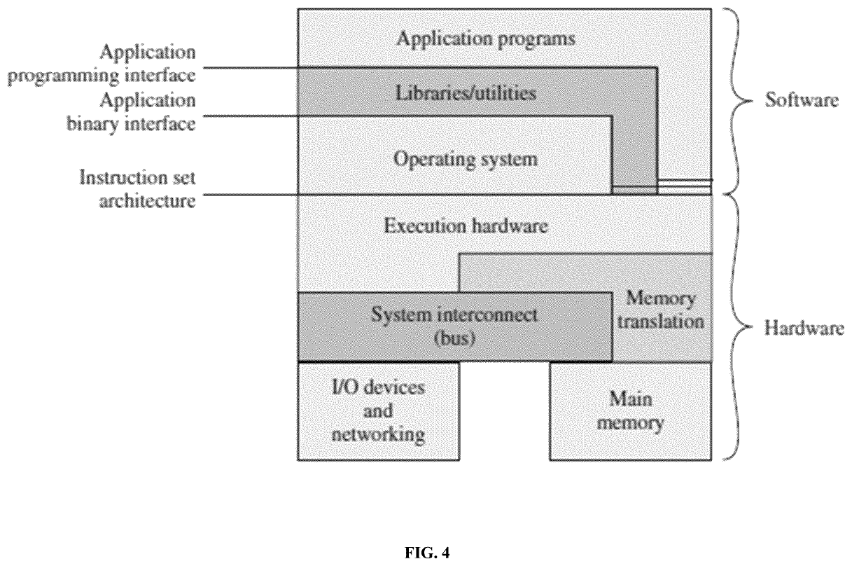

The “hardware-software” stack as referred to in the present disclosure, in some embodiments, do not include both hardware and software. Rather, the hardware-software stack can describe the “vertical” dimension that is now amenable to automatic-differentiation, as described herein (e.g., versus the current paradigm where differentiation may only be feasible “horizontally”). For example, this invention enables autodiff between OS and applications, which, while spanning multiple levels, is entirely in the software section of the hardware-software stack (FIG. 4). In some instances, the present disclosure further enables autodiff between execution hardware, OS and libraries.

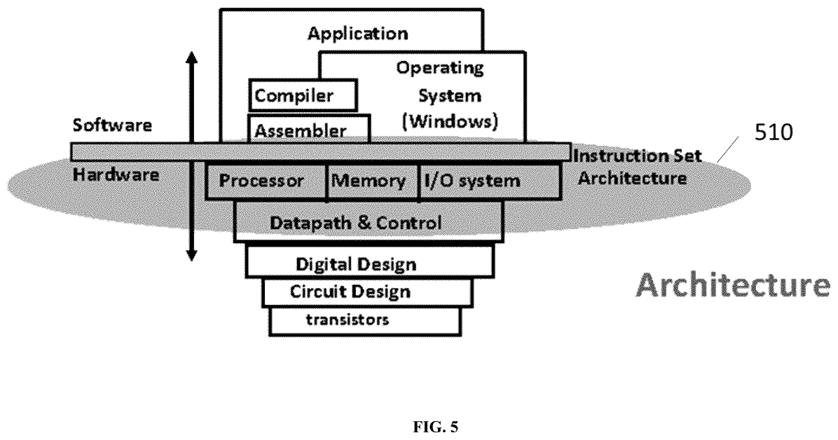

A computer architecture, as generally described herein, refers to the science and art of selecting and/or interconnecting hardware components to create computers that meet any one of functional, performance, or cost goals. A non-limiting example of a computer architecture is shown in FIG. 5. The hardware of the present disclosure includes lower level components, such as circuits and logic. Referring to FIG. 5, the present disclosure enables autodiff for the layers 510 and above (e.g., one or more of those layers/components).

A computer architecture of the present disclosure comprises an abstract virtual machine (VM). AVM can be used to create relevant architectural differences and/or a shared layer running on a variety of substrate compute platforms. Such a VM may have the ability to shape its own architecture (e.g., similarly to the way modem machine learning techniques learn from data). As such, the VM can comprises a reconfigurable architecture. In some instances, the VM comprises a parametrized description of a VM. In some instances, the VM can be optimized based size of the memory, number and width of registers, available instruction set, instruction encoding, implementation of firmware and/or I/O. In some instances, optimization of the parameters of a VM described herein are accomplished by endowing the VM with automatic differentiation capabilities.

In some instances, a VM can comprise automatic differentiation (autodiff) capabilities. Autodiff comprises a native component at the abstraction level of the operating system (OS). The autodiff capabilities can generally refer to emitting gradient programs at intermediate representations (IR) and/or at the instruction set. As an example, a system can emit gradient programs at an intermediate representation (IR) and/or at the instruction set, instead of the original source language. The system is thus able to differentiate programs in a variety of languages for arbitrary programs (e.g., AI/ML, data, and standard software applications) and provide unique optimizations at the hardware-software interface.

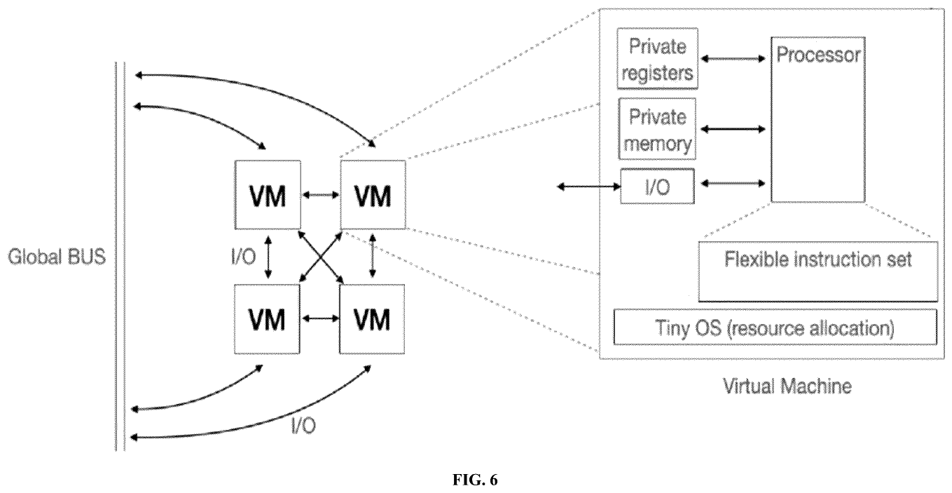

This approach to a VM can be scaled by defining an n-dimensional grid of VMs with flexible and adaptive network topology, as shown in FIG. 6. In some instances, each VM is an abstraction of a compute engine (e.g., CPU, GPU core, etc.). In some instances, each VM has private resources (e.g., not available directly to others). In some instances, the private resources comprises, by way of non-limiting example, any one of: a processor, a flexible instruction set (e.g., executed by the processor), an operation system (e.g., for resource allocation), private registers, private memory, input/output (I/O), or any combination thereof. In some instances, the processors is in communication with any one of private registers, private memory, input/output (I/O), or any combination thereof. In some examples, it may be crucial for the system to be constrained, otherwise full connectivity can make the problem intractable. In some instances, VMs can exchange information through a special I/O register interface. In some examples, data can be passed using global, absolute addressing through the global bus or using relative addressing mode to the neighbors. In some instances, all software executed on a VM is compiled using a compiler with automatic differentiation, such as those described herein. In some instances, global bus is the way of communicating between the grid of VMs with some external interface (for example to write/read data) or other clusters of VMs.

In some instances, the benefits of using a VM can comprise any one of an isolated runtime environment, adjustable low-level knobs, some reconfigurable at runtime, fully observable, no hardware faults caused by incorrectly generated programs, easily portable, tight integration with custom LLVM backend and automatic differentiation, internal firmware responsible for tasks such as scheduling or memory management is also subject to automatic differentiation and optimization, or any combination thereof.

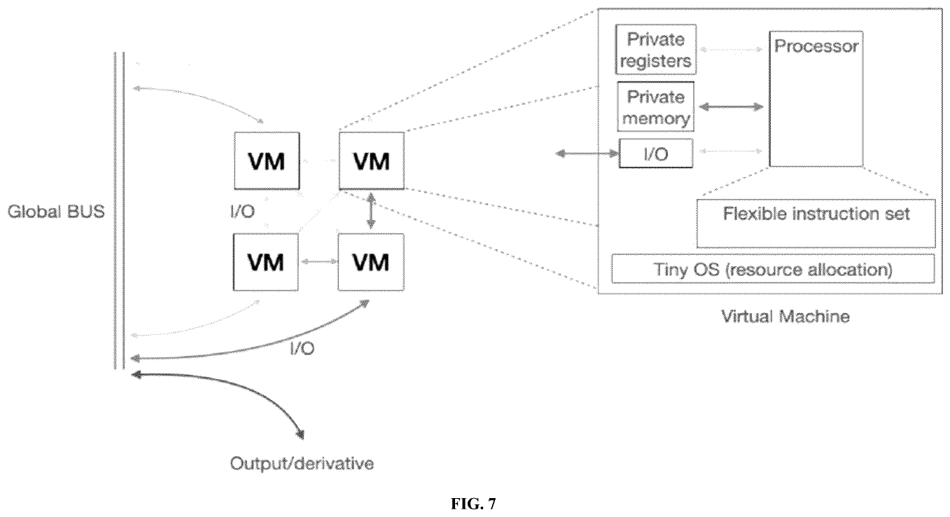

An illustration is provided in FIG. 7, which shows the possible flow of gradients, starting from the program output, going back to private VM resources. Here, the darkness of the flow of gradients corresponds to the magnitude of the gradient (e.g., darker arrow corresponds to larger gradient).

In some instances, one or more VMs are utilized to deploy a production-grade system is optimize for a variety of test applications. In some examples, the system is optimized from scratch for a particular test application. In some instances, a clear criterion for the usefulness of this system is to a) demonstrate online adaptation and/or b) perform some computation in a more efficient way than the best ‘fixed’ architecture can do. In some instances, a successful system comprising one or more VMs, as described herein, provides a blueprint and proof of concept for future, runtime reconfigurable systems. In some instances, this can open the door to a theory of computation which goes beyond Turing-completeness and/or allows for solving a so-called ‘halting problem’.

In some instances, one or more VMs is implemented as a very thin layer written in portable C code. In some instances, one or more VMs is implemented on standard CPUs and/or GPUs (e.g., x86_64 Intel® i7, Apple® M1, embedded ARM cores and even GPU (CUDA), etc.). Thus, in some instances, software can be executed on any machine which supports ANSI C. In some instances, one or more VMs is implemented on an FPGA, ASIC, NVMe, microcontroller, AI-accelerator (e.g., Google-TPU®, Graphcore®, Cerebras®, SambaNova®, etc.), or any combination thereof.

In some examples, a VM is about 100 to about 500 lines of code. In some examples, a VM is about 300 lines of code. In some examples, a VM is about 100 to 200, 100 to 300, 100 to 400, 100 to 500, 200 to 300, 200 to 400, 200 to 500, 300 to 400, 300 to 500, or 400 to 500 lines of code. In some examples, a VM is about 100, 200, 300, 400, or 500 lines of code. In some examples, a VM is at least about 100, 200, 300, 400, or 500 lines of code. In some examples, a VM is at most about 100, 200, 300, 400, or 500 lines of code.

One or more VMs (e.g., an entire network of VMs) can be very generic, and an arbitrary computing system can also be emulated in such way. As a result, in some instances, this provides a highly scalable and portable solution. In some examples, applications of the system described herein to exploit this generality of the VM, while also containing benchmarks on a variety of heterogeneous architectures, including various models of GPU and TPU. In some examples, variety of heterogeneous architectures are in both distributed (e.g., multi- and hybrid-cloud) and/or local (e.g., on-prem) settings.

### Programming Languages and Compilers

In some embodiments, with the imminent end of Moore's Law and Dennard scaling, a diverse set of heterogeneous architectures have been embraces as a way to continue to enable the performance required by data-intensive AI/ML, simulation, and scientific computing systems. In some instances, codebases are written with a given target in mind, which, in addition to presenting problems for users to understand and rewrite their code, can mean that new AI/ML systems must be created to handle new architectures or languages. With the increasing problem complexity and hardware limitations, growing the size of manually optimized libraries may not scale to future demands. Compounding the issue, the complexity of compilers grows with the complexity of computer architectures and workloads. In some instances, currently, to get decent performance for applications running on GPUs (e.g., AI/ML and simulation) and other kinds of accelerators, the best option is to use a specialized compiler tailored for the given accelerator.

As such, the present disclosure systems that operate across hardware architectures and languages with a single framework by operating within a compiler. In some instances, a compiler configured to compile software executed on the one or more VMs. In some instances, a compiler is configured to or is capable of automatic differentiation (autodiff). In some examples, autodiff comprises converting a programming language into machine code processed on heterogeneous hardware, such as those described herein. More specifically, autodiff comprises enabling the conversion of an arbitrary software programs (and systems) in arbitrary programming languages to machine code. Non-limiting examples of programming languages comprise Python®, JavaScript®, Java®, C#, C, C++, Objective-C®, GO®, R®, Swift®, PHP®, Fortran®, APL®, Prolog®, SQL®, Matlab®, Julia®, Ada®, ALGOL®, Lisp®, Dart®, Ruby®, Rust®, etc. Further, the conversion enabled by autodiff can be processed on non-specific hardware, including heterogeneous hardware combinations.

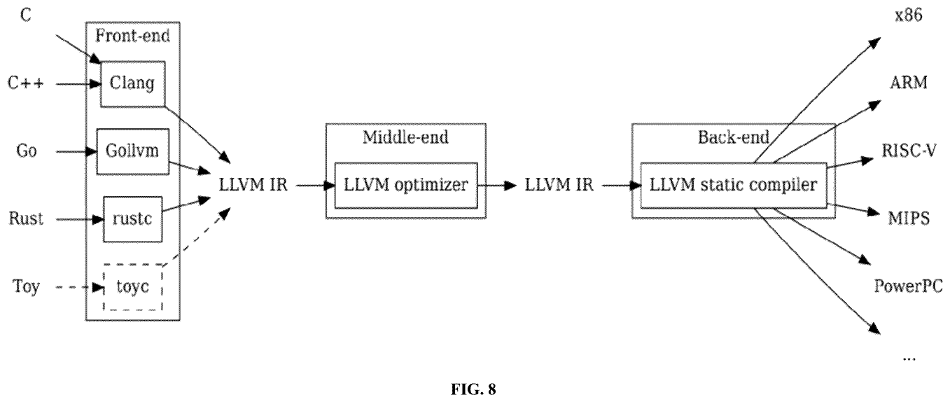

In some instances, a Multi-Level Intermediate Representation (MLIR) is analyzed as a possible alternative to a low-level intermediate representation (LLVM IR) used by a LLVM compiler framework (FIG. 8). In some instances, the MLIR is a target layer for autodiff. In some embodiments, the objective of the system comprises a generic solution that is agnostic to the (LLVM) frontend. In some embodiments, autodiff is added as a native component of the compiler.

In some instances, an initial validation of a compiler comprising autodiff comprises a tool that takes arbitrary existing code as LLVM IR and computes the derivative (and gradient) of that function. As an example, this can allow developers to use Enzyme to automatically create gradients of their source code without much additional work. In such an example, by working at the LLVM level, Enzyme is able to differentiate programs in a variety of languages (C, C++, Swift, Julia, Rust, Fortran, TensorFlow, etc.) in a single tool and achieve high performance by integrating with LLVM's optimization pipeline.

While there exist tools for doing automatic differentiation in C++, for example, including Adept or autodiff, these tools are frameworks that require a complete rewrite of the software to use the library-specific call. Further, a direct one-to-one mapping is not always guaranteed in these frameworks. Additionally, rewriting entire software projects can be resource-intensive, time-consuming, and/or error prone. In some instances, having a high-performance automatic differentiation implementation in a programming language, for example C++, can make the difference between having a suitable solution for, e.g., uncertainty estimation, or abandoning it due to computational complexity. In some examples, this is a bottleneck and is pervasive in AI/ML (notably in robotics), as well as large-scale distributed computing. In some examples, this bottleneck is extended to analogous scenarios, such as the inability to run automatic differentiation efficiently at various levels of a stack and in various (or mixed) programming languages, which can significantly constrain what a user considers possible.

With the ability to have gradient-based information at the compiler, there are several possible advances in the realm of programming languages. The first possible advantage comprises probabilistic programming. The probabilistic programming paradigm equates probabilistic generative models with executable programs. Probabilistic programming languages (PPL) enable practitioners to leverage the power of programming languages to create rich and complex models, while relying on a built-in inference backend to operate on any model written in the language, as previously described herein. In some instances, PPL use can suffer due to computational cost. In some instances, efficient PPL (e.g., Infer.net, BUGS, Edward, etc.) are those which constrain the scope of modeling and inference in order to implement narrow, often hardware-specific PPL.

The second possible advantage comprises domain-specific languages (DSL). The use of a DSL can make it possible to operate close to the ‘metal’ and further optimize with gradients that are hardware-aware. As an example, as a proof of concept, the DSL “GraphIt®” can leverage machine programming for computing on graphs of various sizes and structures on various underlying hardware. As a further example, in the realm of “intentional programming”, the Halide programming language (rather, DSL embedded in C++) was designed with two primary components for two different types of programmers: (i) an algorithmic DSL for domain experts and (ii) the scheduling component for programmers with a deep understanding of building optimal software for a given hardware target.

The third possible advantage comprises differentiable programming (DP). DP is a programming paradigm in which derivatives of a program are automatically computed and used in gradient-based optimization in order to tune the program to achieve a given objective, as previously described herein. DP can be used in a wide variety of areas, particularly scientific computing and ML. However, languages are often designed for a single layer of the software-hardware stack. In some instances, a relatively simple syntax and set of operators is developed for the full-stack DP for a system of the present disclosure.

In some embodiments, an autodiff-native compiler is used to overcome challenges of system heterogeneity. In some instances, the challenges comprise understanding interoperability across applications and across devices, its semantics in the presence of extreme variations in abstractions, and/or how the semantics can be engineered within programming languages and compilers to obtain scalability and correctness across the full hardware/software stack.

In some instances, consideration for obtaining scalability comprises complexities of parallel and distributed computing software, different computing architectures (e.g., ISA, cache, SIMD, etc.), as well as complexities of memory hierarchies, network topologies and/or heterogeneity. However, scalability can be simplified by using one or more VMs. As an example, scalability can be achieved by creating a virtual machine based abstraction for any computation and data movement to execute models, such as those described herein. In some instances, a virtual machine (VM) models a single compute element. In some instances, communication between VMs is abstracted. In some instances, no assumption is made about a property of a system, including, but not limited to size, shape and/or architecture of a system. In some instances, such properties of the system are discovered online, and as such the system can be scaled up freely. In some examples, power consumption comprises a limiting factor. However, optimization of the system itself can ensures that a task should be performed as quickly as possible, using as little resources as possible. In some examples, this leads to lower power consumption.

In some instances, consideration for obtaining correctness comprises a low-level implementation of the VM itself, the emulator engine and the glue code which is responsible for ‘clock ticks’. In some instances, the VM is implemented on any heterogeneous architectures described herein. In some instances, whether the emulator engine is implemented correctly, is evaluated through one or more self-tests, which can test any combination of instructions, perform memory and register moves, and/or arithmetic operations, and produce a checksum at the end.

In some instances, consideration for obtaining correctness comprises a higher-level functionality of the system. The disclosure described herein provides methods and systems for automatically generating computer programs. However, it may be hard to determine if a generated and never-before executed program is correct. In some instances, the systems described herein comprise a verification mechanism. In some examples, the verification mechanism takes a program as an input and returns a probability that its execution is going to terminate and/or a probability that the output is reliable. In some examples, the verification mechanism is implemented to endow the system with a program for modeling uncertainty. In some examples, the program is generated with inherent stochasticity and a distribution of programs can be estimated. In some examples, the program comprises a similar approach to a Variational Auto-Encoder (e.g., where it is possible to determine if a sample is out-of-distribution). In some examples, once a program is generated, a ground truth can be obtained. In some examples, if the output is not desirable, then it serves as a negative sample. In some instances, this approach entails continuous data generation (positive/negative samples), verification and/or adaptation as a way of ensuring that the data used for training the system is correct.

In some instances, working at a lower level enabled by automatic differentiation allows manipulation and handling of lower level primitives (e.g., vector instructions, memory, I/O, etc.). As an example, some Julia automatic differentiation tools do not handle mutable memory and do not vectorize well, whereas Enzyme can be able to with developments, described herein.

In some instances, the LLVM infrastructure can be employed to enable usage of any existing and future front end.

In some instances, a new syntax is developed to support automatic differentiation and/or online-learning. In some examples, this can produce contributions in LLVM-IR layer and LLVM backend.

In some instances, any arbitrary hardware can be employed with the use of a VM as an abstraction of a core. In some examples, this almost removes the problem of programming heterogeneous machines. As an example, for a system with 4 GPUs and 16 CPUs, about 1000 VM units can run on GPUs and about 500 on CPUs. In some examples, about 10,000 VM units can be run on a GPU. In some examples, about 500 to about 20,000 VM units run on a GPU. In some examples, about 500 to about 1,000, about 500 to about 1,500, about 500 to about 2,000, about 500 to about 5,000, about 500 to about 8,000, about 500 to about 10,000, about 500 to about 15,000, about 500 to about 20,000, about 1,000 to about 1,500, about 1,000 to about 2,000, about 1,000 to about 5,000, about 1,000 to about 8,000, about 1,000 to about 10,000, about 1,000 to about 15,000, about 1,000 to about 20,000, about 1,500 to about 2,000, about 1,500 to about 5,000, about 1,500 to about 8,000, about 1,500 to about 10,000, about 1,500 to about 15,000, about 1,500 to about 20,000, about 2,000 to about 5,000, about 2,000 to about 8,000, about 2,000 to about 10,000, about 2,000 to about 15,000, about 2,000 to about 20,000, about 5,000 to about 8,000, about 5,000 to about 10,000, about 5,000 to about 15,000, about 5,000 to about 20,000, about 8,000 to about 10,000, about 8,000 to about 15,000, about 8,000 to about 20,000, about 10,000 to about 15,000, about 10,000 to about 20,000, or about 15,000 to about 20,000 VM units run on a GPU. In some examples, about 500, 1,000, 1,500, 2,000, 5,000, 8,000, 10,000, 15,000, or 20,000 VM units run on a GPU. In some examples, at least about 500, 1,000, 1,500, 2,000, 5,000, 8,000, 10,000, 15,000, or 20,000 VM units run on a GPU. In some examples, at most about 500, 1,000, 1,500, 2,000, 5,000, 8,000, 10,000, 15,000, or 20,000 VM units run on a GPU. In some examples, about 100 to about 1,000 VM units can run on a CPU. In some examples, about 100 to 500, 100 to 700, 100 to 1000, 500 to 700, 500 to 1,000, or 700 to 1,000 VM units run on a CPU. In some examples, about 100, 200, 300, 400, 500, 600, 700, 800, 900, or 1,000 VM units run on a CPU. In some examples, at least about 100, 200, 300, 400, 500, 600, 700, 800, 900, or 1,000 VM units run on a CPU. In some examples, at most about 100, 200, 300, 400, 500, 600, 700, 800, 900, or 1,000 VM units run on a CPU.

DP can describe a powerful concept in deep learning, which comprises parameterized software modules that can be trained with some form of gradient-based optimization. The autodiff technologies described herein (e.g., compiler, OS, etc.) can have similar impact, but for the full software-hardware stack. That is, gradient-based optimization for, by way of non-limiting example, hardware-software codesign, scheduling (compiler instructions, jobs in single-core and multi-processor settings, etc.), resource management and task allocation, or large scale and heterogeneous computing (including peta- and exa-scale systems).

Compared to the majority of automatic differentiation tools that differentiate programs at compile-time (e.g., Fortran, C, etc.) Enzyme can be based on the LLVM compiler instead of an automatic differentiation-specific framework, as well as emits gradient programs in LLVM IR instead of the original source language. This approach can allow Enzyme to benefit from the language support, optimizations, and/or maturity of the LLVM platform.

In some instances, since GPU kernels can be generated by the LLVM compiler, Enzyme comprises the first fully automatic reverse-mode automatic differentiation tool to generate gradients of GPU kernels. As an example, a system can run Enzyme for HPC applications on NVIDIA and AMD GPUs with a runtime overhead of <20x. In some examples, Enzyme can be evolved to improve at least an order of magnitude. In some examples, Enzyme can be applied to (and proven on) more heterogeneous computing platforms.

### Systems for AI/ML, Simulation, Scientific Computing and Data-Driven Technologies

A system as referred to herein can comprise a dynamic combination of software, hardware, data, algorithms, and/or people. Challenges associated with systems for AI/ML, simulation, scientific computing, and data-driven technologies can be pervasive across domains and throughout the stack. As an example, the proliferation of heterogeneous hardware and domain-specific libraries/frameworks makes systems non-trivial to build (let alone optimize and/or maintain) with generalized tools or algorithms. In some instances, optimizing across components is increasingly important to achieve maintainable and adaptive scalability across the full hardware-software stack.

Further, computing environments can be increasingly distributed and can be inherently at risk to security issues, such as edge computing and public clouds (very often used in scientific research settings with sensitive datasets). In some embodiments, these security issues motivate the development, validation, and/or communication of guiding principles of large-scale system design. In some instances, novel approaches to systems of the present disclosure comprise (a) machine-programmable pipelines for auto-generating optimal configurations of system components, and/or (b) systems engineering for AI/ML and simulation technologies. The machine-programmable pipelines of (a) can be enabled strictly due to the novelties of the multi-layer differentiability of the hardware-software stack. The systems engineering in (b) comprises a proven framework that can be implemented for simulation intelligence, and can enable the development of reliable and scalable learning/simulation technologies.

In some embodiments, in simulation intelligence and/or computer systems generally, a guiding principle for system development comprises ways to build reliable systems with unreliable components. Non-limiting examples of unreliable components comprise noisy and faulty sensors, human and AI error, etc. As such, there can be significant value to quantifying uncertainties, propagating them throughout a system, and arriving at a notion or measure of reliability. In some instances, principled uncertainty propagation is useful, module to module, up-and-down abstraction levels. With the full-stack automatic differentiation methods described herein, this local and global type of uncertainty propagation may be possible. At abstraction levels of the hardware-software stack described herein, uncertainty-aware methods and corresponding metrics may be provided. As such, the hardware-software stack described herein may provide theoretically grounded and empirically validated measures of AI systems reliability.

In some instances, with continual changes in hardware platforms (and combinations with wide-ranging sensors, data streams, etc.), maintaining correctness, robustness, and accuracy may be concerns. As an example, programs can often give unexpected results on different platforms owing to differences in hardware semantics (e.g., such as various memory types and memory consistency models). By quantifying uncertainties at all levels of the hardware-software stack, including the information flow between levels, a principled, real-time uncertainty measures for heterogeneous systems and essentially all scales may be provided.

In some instances, in addition to machine programming, computer architecture, programming languages and compilers, and the systems described herein, substantial advancements may be made in the context of high-performance computing (HPC). In some examples, the advancements may be due to application areas encompassing simulation systems and scientific computing.

### Target Applications and Systems

In some instances, target applications and systems described herein comprise those that expose challenges described herein. In some instances, the target applications and systems described herein comprise valuable real-world applications of the technologies. In some instances, the target applications and systems described herein are diverse in many ways, such as, for example, data types, computational platforms, and deployment settings and their efficiency and sensitivity requirements. In some instances, the target applications comprise an open-source codebase that can be run on the systems and methods described herein. In some examples, such open-source codebases can be used for benchmarking of the systems and methods described herein.

An example target application and corresponding system comprises earth systems modeling. In some instances, the earth systems modeling comprises an open-source codebase, such as a “versatile ocean simulator” (“Veros®”), which aims to enable high-performance ocean modeling with a clear focus on flexibility and usability. Veros comprises a full-fledged primitive equation ocean model that supports anything between idealized toy models and realistic, high-resolution, global ocean simulations. Veros can support a NumPy backend for small-scale problems, and a high-performance JAX backend with CPU and GPU support. It is fully parallelized via MPI and supports distributed execution on any number of nodes, including multi-GPU architectures. The dynamical core of Veros is based on pyOM2, an ocean model with a Fortran backend and Fortran and Python frontends. The open-source Veros project also includes benchmarks that can be used directly and repurposed for our methods and systems (and the engineering sciences in general).

In addition to this ocean simulator, several complementary SI systems can be introduced. In some instances, a complementary SI system comprises modeling atmospheric transport of pollutants, nuclear winter simulation, and/or large-scale simulation pipeline for space weather. In the atmospheric transport case a challenge comprises executing a HPC physics-based numerical simulations on cost-effective hardware. In some examples, ML-based surrogate modeling techniques are utilized to automatically identify the compute bottlenecks and replace them with data-driven surrogates that are magnitudes more efficient. In some examples, MP-based methods are utilized. In some examples, the complementary SI systems involve heterogeneous software-hardware stack components, various programming languages (e.g., Julia, Python, C++, Fortran, etc.), and deployment settings including HPC (e.g., both hybrid- and multi-cloud setups).

An example target application and corresponding system comprises energy grid simulation and optimization. In some instances, open-source modeling and simulation systems for energy grids provide testbeds for methods and system described herein. Such open-source systems include the Breakthrough Energy open-source energy systems model and the DOE Grid Optimization Competition. In some examples, the latter can further provide benchmarking datasets and results for evaluating the new class of methods developed, as described herein.

An example target application and corresponding system comprises machine learning optimization of experimental design. ML algorithms can be used for designing experiments such that the outcomes will be as informative as possible about the underlying processes. Outer-loop algorithms are often used, but valuable information can be lost in the experiment settings that are more complex and error-prone than simple testbeds. In some instances, optimization of ML algorithms is non-trivial, especially with heterogeneous experiment platforms. In some instances, for ML-based optimization, a system-wide differentiability described herein is useful. As an example, a forward looking use-case with simulation intelligence comprises a “biotech laboratory infrastructure” and “cloud labs” (e.g., Emerald Cloud Lab®), which may also necessitate the machine programming and autodiff technologies.

An example target application and corresponding system comprises AI-driven sensor design. AI-enabled sensor design comprises the use of inverse design and related machine learning techniques to optimally design data acquisition hardware with respect to a user-defined cost function or design constraint. Such an approach can drastically improve the overall performance of a sensor and broader data ingestion/modeling system. In some examples, this can be accompanied by a non-intuitive design choice. As an example, soil (and carbon) sensor data from Microsoft's Climate group (as well as NASA) can be used in this target application and system.

Beyond the use of these applications described herein, operationalizing the datasets, challenges, codebases, etc. towards a novel MP benchmark can also be important in developing the technologies described herein. MP has largely been developed and evaluated on typical use-cases, for example, with NLP benchmarks. Science and engineering are differentiated from NLP and other mainstream ML in many ways, implying there are more challenges and opportunities to test, break, and improve MP (not to mention unknown unknowns to discover) within real-world applications.

A MP benchmark can have multiple levels, each measuring a slightly different property, but when a single number is used, then the default, level A numbers can be compared. In some examples, a class of MP benchmark comprises (A) given sufficiently many examples of <input, output> pairs, infer the program which explains the data best and obtain test set accuracy using this program. <input, output> pairs are generated using a ‘hidden’ program which is drawn from some parameterized family of algorithms. In addition to preferring correct programs over incorrect ones, an additional score can be given for faster execution (when two or more programs produce the same, correct results). In some examples, a class of MP benchmark comprises (B) like A, but in addition to providing raw <input, output> pairs, an additional input per sample is allowed which may be either text (copilot-style comments guiding the system) or image. This measures if a program which has been learned can quickly adapt to a new task. For example, one may expect one program to learn to sort, regardless of the data type (integer or string). The data type information can be that extra piece of information. In some examples, a class of MP benchmark comprises (C) self-assessment of the model. Given a prompt, the system is asked to generate a program and given an estimate of the uncertainty of this solution. In other words, whether the system is ‘very confident’ or not is assessed. In some examples, this is done by measuring the cross-entropy between the ground truth and the prediction. In some examples, a class of MP benchmark comprises (D) predict the output of a <input, program> pair. This effectively may need to solve a task such as the halting problem. Tasks C and D can be combined to produce both the prediction as well as the confidence level.

Provided herein are technologies that can efficiently, dynamically, and reliably exploit heterogeneous hardware accelerators. This can be accompanied by architectural platforms for scaling existing systems and supporting new ones. Provided herein are a class (or paradigm) of methods to innovate in this area (e.g., a SI-MP “flywheel”), but also a fundamental requirement for this direction of innovation to proceed in a reliable fashion: the MP Benchmark. Such MP Benchmark can critically evaluate scalability with a variety of real-world empirical challenges that exploit heterogeneous combinations across the hardware-software stack. The present disclosure explores all levels of the hardware-software stack, and simultaneously facilitates improved reasoning about key systems properties, such as correctness and accuracy. To this end, scalability is also evaluated end-to-end (see Example 1) with respect to the full hardware-software stack. In some instances, innovations and changes in specific parts of the hardware-software stack can have effects that propagate throughout the system (and perhaps in hidden ways that are masked by abstraction).

The earth systems and energy grid applications presented herein provides an example of an extreme scale modeling and simulation application. In some instances, extreme scale modeling and simulation application call for modeling complex phenomena more holistically across multiple scales and physics, and require high-resolution, dynamic, coupled simulation workflows. In some instances, these applications integrate data analytics as well as new AI/ML approaches, both at massive scales. As such, complexity and scale of the resulting SI workflows can present new challenges and requirements for future advanced computing ecosystem. In some instances, the integration of coupled models, data, and analytics require composable execution environments that integrate appropriate resources and capabilities, as well as directly addressed within the present disclosure with generalizable, extensible technologies.

### Artificial Intelligence (AI) and Machine Learning (ML) Approaches

The systems of the present disclosure can comprise a platform for or that are built using one or more AI/ML approaches. AI approaches generally comprises intelligence demonstrated by a machine that is commonly associated with an intelligent being. In some embodiments, AI comprises probabilistic methods (e.g., Bayesian network, Hidden Markov model, Kalman filter, Particle filter, Decision theory, Utility theory, etc.). In some embodiments, AI comprises logic such as, but not limited to, propositional logic, first-order logic, fuzzy logic, default logic, non-monotonic logics, description logic, situation calculus, event calculus, fluent calculus, causal calculus, belief calculus, modal logics, and paraconsistent logic. In some embodiments, AI comprises search and optimization algorithms (e.g., random optimization, beam search, metaheuristics, such as simulated annealing, etc.). In some embodiments, search and optimization algorithms comprise evolutionary algorithms, including, but not limited to genetic algorithms, gene expression programming, and genetic programming. In some embodiments, AI comprises symbolic AI based on high-level symbolic (e.g., human-readable) representations of problems, logic and search. In some embodiments, AI comprises specialized languages (e.g., Lisp, Prolog, TensorFlow, etc.). In some embodiments, AI comprises natural language processing (NLP). In some embodiments, AI comprises specialized hardware (e.g., AI accelerators, neuromorphic computing, etc.). In some embodiments, AI comprises ML approaches comprising classifiers and/or statistical learning. In some embodiments, AI comprises ML approaches comprising artificial neural networks (e.g., feedforward neural networks, recurrent neural networks, etc.). In some embodiments, AI comprises ML approaches comprising deep learning.

In some instances, the one or more machine learning (ML) approaches are supervised, semi-supervised, or unsupervised. In some instances, the one or more ML approaches perform classification or clustering. In some examples, the machine learning approach comprises a classical machine learning method, such as, but not limited to, support vector machine (SVM) (e.g., one-class SVM), K-nearest neighbor (KNN), isolation forest, random forest, or any combination thereof. In some examples, the machine learning approach comprises a deep leaning method (e.g., deep neural network (DNN)), such as, but not limited to a convolutional neural network (CNN) (e.g., one-class CNN), recurrent neural network (RNN), transformer, graph neural network (GNN), convolutional graph neural network (CGNN), or any combination thereof.

In some embodiments, a classical ML method comprises one or more algorithms that learns from existing observations (e.g., selected features) to predict outputs. In some embodiments, the one or more algorithms perform clustering of data. In some examples, the classical ML algorithms for clustering comprise K-means clustering, mean-shift clustering, density-based spatial clustering of applications with noise (DBSCAN), expectation-maximization (EM) clustering (e.g., using Gaussian mixture models (GMM)), agglomerative hierarchical clustering, or any combination thereof. In some embodiments, the one or more algorithms perform classification of data. In some examples, the classical ML algorithms for classification comprise logistic regression, naïve Bayes, KNN, random forest, isolation forest, decision trees, gradient boosting, support vector machine (SVM), or any combination thereof. In some examples, the SVM comprises a one-class SMV or a multi-class SVM.

In some embodiments, the deep learning method comprises one or more algorithms that learns by extracting new features to predict outputs. In some embodiments, the deep learning method comprises one or more layers. In some embodiments, the deep learning method comprises a neural network (e.g., DNN comprising more than one layer). Neural networks generally comprise connected nodes in a network, which can perform functions, such as transforming or translating input data. In some embodiments, the output from a given node is passed on as input to another node. The nodes in the network generally comprise input units, hidden units, output units, or a combination thereof. In some embodiments, an input node is connected to one or more hidden units. In some embodiments, one or more hidden units is connected to an output unit. The nodes can generally take in input through the input units and generate an output from the output units using an activation function. In some embodiments, the input or output comprises a tensor, a matrix, a vector, an array, or a scalar. In some embodiments, the activation function is a binary step activation function, linear activation function, Rectified Linear Unit (ReLU) activation function, leaky ReLU activation function, parameterized ReLU, a sigmoid activation function, a hyperbolic tangent activation function, a Softmax activation function, exponential linear unit, or a Swish activation function.

The connections between nodes further comprise weights for adjusting input data to a given node (e.g., to activate input data or deactivate input data). In some embodiments, the weights are learned by the neural network. In some embodiments, the neural network is trained to learn weights using gradient-based optimizations. In some embodiments, the gradient-based optimization comprises one or more loss functions (e.g., Binary Crossentropy, Binary Focal Crossentropy, Categorical Crossentropy, Categorical Hinge, Cosine Similarity, Hinge, Huber, KL Divergence, LogCosh, Mean Absolute Error, Mean Absolute Percentage Error, Mean Squared Error, Mean Squared Logarithmic Error, Poisson, Reduction, Sparse Categorical Crossentropy, Squared Hinge, etc.). In some embodiments, the gradient-based optimization is gradient descent, conjugate gradient descent, stochastic gradient descent, or any variation thereof (e.g., adaptive moment estimation (Adam)). In some further embodiments, the gradient in the gradient-based optimization is computed using backpropagation. In some embodiments, the nodes are organized into graphs to generate a network (e.g., graph neural networks). In some embodiments, the nodes are organized into one or more layers to generate a network (e.g., feed forward neural networks, convolutional neural networks (CNNs), recurrent neural networks (RNNs), etc.). In some embodiments, the CNN comprises a one-class CNN or a multi-class CNN.

In some embodiments, the neural network comprises an autoencoder. In some embodiments, the autoencoder comprises an encoder and a decoder. In some embodiments, the encoder reduced the dimensionality of an input and a decoder regenerates the input. As such, the encoding process is validated and refined through attempts to regenerate the input. In some embodiments, an autoencoder can learn a representation of a data set through training that ignores insignificant portion of a data set. In some embodiments, the autoencoder comprises a regularized autoencoder, a concrete autoencoder, or a variational autoencoder (VAE). In some embodiments, an autoencoder is used for dimensionality reduction, information retrieval, anomaly detection, image processing, drug discovery, popularity prediction, or machine translation.

In some embodiments, the neural network comprises an generative adversarial network (GAN). In some embodiments, a GAN comprises at least two neural networks. In some embodiments, one of the at least two neural networks comprises a generative network. In some embodiments, the generative network comprises a statistical model of the joint probability distribution P(X,Y) on given observable variable X and target variable Y. In some embodiments, one of the at least two neural networks comprises a discriminative network. In some embodiments, the discriminative network comprises a statistical model of the conditional probability P(Y|X=x) of the target Y, given an observation x. In some embodiments, the generative network learns to map from a latent space to a data distribution of interest, while the discriminative network distinguishes candidates produced by the generator from the true data distribution.

In some embodiments, the neural network comprises one or more recurrent layers. In some embodiments, the one or more recurrent layers are one or more long short-term memory (LSTM) layers or gated recurrent units (GRUs). In some embodiments, the one or more recurrent layers perform sequential data classification and clustering in which the data ordering is considered (e.g., time series data). In such embodiments, future predictions are made by the one or more recurrent layers according to the sequence of past events. In some embodiments, the recurrent layer retains or “remembers” important information, while selectively “forgets” what is not essential to the classification.

In some embodiments, the neural network comprises one or more convolutional layers. In some embodiments, the input and the output are a tensor representing variables or attributes in a data set (e.g., features), which may be referred to as a feature map (or activation map). In such embodiments, the one or more convolutional layers are referred to as a feature extraction phase. In some embodiments, the convolutions are one dimensional (1D) convolutions, two dimensional (2D) convolutions, three dimensional (3D) convolutions, or any combination thereof. In further embodiments, the convolutions are 1D transpose convolutions, 2D transpose convolutions, 3D transpose convolutions, or any combination thereof.

In some embodiments, the neural network comprises one or more attention layers. An attention layer may generally enhance some parts of a data set while diminishing others. As such, an attention layer can be used for processing or analyzing various types of data, such as language or sensory data (e.g., sound, image, video, text, etc.). In some embodiments, an attention layer comprises a function that can take a representation of an element and map it to a scalar value, called an “attention weight”. An attention weight may generally highlight how machine learning model or layer therein adjusts focuses or “weights” features within a data set. In some embodiments, an attention layer is in between one or more layers of a neural network, such as those described herein. In some embodiments, a neural network comprising one or more attention layers comprises a transformer, a self-attention neural network, a multi-headed attention neural network, or a gated attention neural network.

The layers in a neural network can further comprise one or more pooling layers before or after a convolutional layer. In some embodiments, the one or more pooling layers reduces the dimensionality of a feature map using filters that summarize regions of a matrix. In some embodiments, this down samples the number of outputs, and thus reduces the parameters and computational resources useful for the neural network. In some embodiments, the one or more pooling layers comprises max pooling, min pooling, average pooling, global pooling, norm pooling, or a combination thereof. In some embodiments, max pooling reduces the dimensionality of the data by taking the maximums values in the region of the matrix. In some embodiments, this helps capture the most significant one or more features. In some embodiments, the one or more pooling layers is one dimensional (1D), two dimensional (2D), three dimensional (3D), or any combination thereof.

The neural network can further comprise of one or more flattening layers, which can flatten the input to be passed on to the next layer. In some embodiments, a input (e.g., feature map) is flattened by reducing the input to a one-dimensional array. In some embodiments, the flattened inputs can be used to output a classification of an object. In some embodiments, the classification comprises a binary classification or multi-class classification of visual data (e.g., images, videos, etc.) or non-visual data (e.g., measurements, audio, text, etc.). In some embodiments, the classification comprises binary classification of an image (e.g., cat or dog). In some embodiments, the classification comprises multi-class classification of a text (e.g., identifying hand-written digits)). In some embodiments, the classification comprises binary classification of a measurement. In some examples, the binary classification of a measurement comprises a classification of a system's performance using the physical measurements described herein (e.g., normal or abnormal, normal or anormal).

The neural networks can further comprise of one or more dropout layers. In some embodiments, the dropout layers are used during training of the neural network (e.g., to perform binary or multi-class classifications). In some embodiments, the one or more dropout layers randomly set some weights as 0 (e.g., about 10%, 20%, 30%, 40%, 50%, 60%, 70%, 80% of weights). In some embodiments, the setting some weights as 0 also sets the corresponding elements in the feature map as 0. In some embodiments, the one or more dropout layers can be used to avoid the neural network from overfitting.

The neural network can further comprise one or more dense layers, which comprises a fully connected network. In some embodiments, information is passed through a fully connected network to generate a predicted classification of an object. In some embodiments, the error associated with the predicted classification of the object is also calculated. In some embodiments, the error is backpropagated to improve the prediction. In some embodiments, the one or more dense layers comprises a activation function, such as those described herein (e.g., Softmax function). In some embodiments, the activation function converts a vector of numbers to a vector of probabilities. In some embodiments, these probabilities are subsequently used in classifications.

### Computer Systems

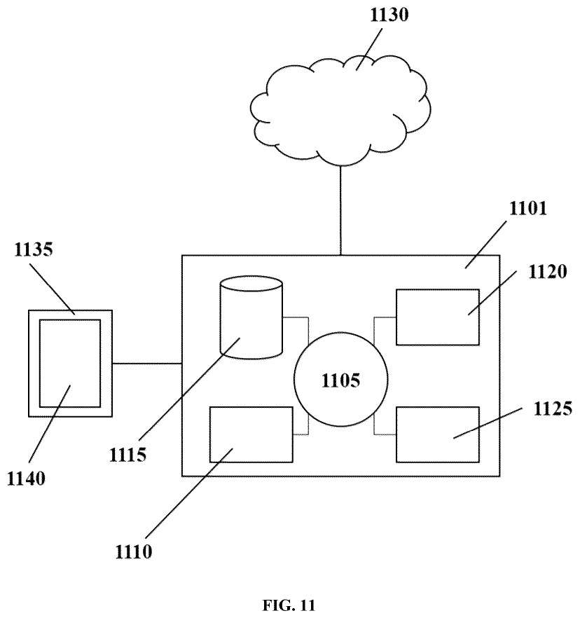

In an aspect, the present disclosure provides computer systems that are programmed or otherwise configured to implement methods of the disclosure, e.g., any of the subject methods for medical imaging. FIG. 11 shows a computer system 1101 that is programmed or otherwise configured to implement methods described herein. The computer system 1101 can be an electronic device of a user or a computer system that is remotely located with respect to the electronic device. The electronic device can be a mobile electronic device.

The computer system 1101 may include a central processing unit (CPU, also “processor” and “computer processor” herein) 1105, which can be a single core or multi core processor, or a plurality of processors for parallel processing. The computer system 1101 also includes memory or memory location 1110 (e.g., random-access memory, read-only memory, flash memory), electronic storage unit 1115 (e.g., hard disk), communication interface 1120 (e.g., network adapter) for communicating with one or more other systems, and peripheral devices 1125, such as cache, other memory, data storage and/or electronic display adapters. The memory 1110, storage unit 1115, interface 1120 and peripheral devices 1125 are in communication with the CPU 1105 through a communication bus (solid lines), such as a motherboard. The storage unit 1115 can be a data storage unit (or data repository) for storing data. The computer system 1101 can be operatively coupled to a computer network (“network”) 1130 with the aid of the communication interface 1120. The network 1130 can be the Internet, an internet and/or extranet, or an intranet and/or extranet that is in communication with the Internet. The network 1130 in some cases is a telecommunication and/or data network. The network 1130 can include one or more computer servers, which can enable distributed computing, such as cloud computing. The network 1130, in some cases with the aid of the computer system 1101, can implement a peer-to-peer network, which may enable devices coupled to the computer system 1101 to behave as a client or a server.

The CPU 1105 can execute a sequence of machine-readable instructions, which can be embodied in a program or software. The instructions may be stored in a memory location, such as the memory 1110. The instructions can be directed to the CPU 1105, which can subsequently program or otherwise configure the CPU 1105 to implement methods of the present disclosure. Examples of operations performed by the CPU 1105 can include fetch, decode, execute, and writeback.

The CPU 1105 can be part of a circuit, such as an integrated circuit. One or more other components of the system 1101 can be included in the circuit. In some cases, the circuit is an application specific integrated circuit (ASIC).

The storage unit 1115 can store files, such as drivers, libraries and saved programs. The storage unit 1115 can store user data, e.g., user preferences and user programs. The computer system 1101 in some cases can include one or more additional data storage units that are located external to the computer system 1101 (e.g., on a remote server that is in communication with the computer system 1101 through an intranet or the Internet).

The computer system 1101 can communicate with one or more remote computer systems through the network 1130. For instance, the computer system 1101 can communicate with a remote computer system of a user (e.g., a subject, an end user, a consumer, a healthcare provider, an imaging technician, etc.). Examples of remote computer systems include personal computers (e.g., portable PC), slate or tablet PC's (e.g., Apple® iPad, Samsung® Gala11 Tab), telephones, Smart phones (e.g., Apple® iPhone, Android-enabled device, Blackberry®), or personal digital assistants. The user can access the computer system 1101 via the network 1130.

Methods as described herein can be implemented by way of machine (e.g., computer processor) executable code stored on an electronic storage location of the computer system 1101, such as, for example, on the memory 1110 or electronic storage unit 1115. The machine executable or machine readable code can be provided in the form of software. During use, the code can be executed by the processor 1105. In some cases, the code can be retrieved from the storage unit 1115 and stored on the memory 1110 for ready access by the processor 1105. In some situations, the electronic storage unit 1115 can be precluded, and machine-executable instructions are stored on memory 1110.

The code can be pre-compiled and configured for use with a machine having a processor adapted to execute the code or can be compiled during runtime. The code can be supplied in a programming language that can be selected to enable the code to execute in a pre-compiled or as-compiled fashion.

Aspects of the systems and methods provided herein, such as the computer system 1101, can be embodied in programming. Various aspects of the technology may be thought of as “products” or “articles of manufacture” typically in the form of machine (or processor) executable code and/or associated data that is carried on or embodied in a type of machine readable medium. Machine-executable code can be stored on an electronic storage unit, such as memory (e.g., read-only memory, random-access memory, flash memory) or a hard disk. “Storage” type media can include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium, such as computer-executable code, may take many forms, including but not limited to, a tangible storage medium, a carrier wave medium or physical transmission medium. Non-volatile storage media including, for example, optical or magnetic disks, or any storage devices in any computer(s) or the like, may be used to implement the databases, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

The computer system 1101 can include or be in communication with an electronic display 1135 that comprises a user interface (UI) 1140 for providing, for example, a portal for interacting with one or more layers of a stack (e.g., FIG. 1 or FIG. 4) or in a computer architecture (e.g., FIG. 5) as described herein. In some embodiments, the portal can interact with one or more VMs, as described herein. The portal may be provided through an application programming interface (API). A user or entity can also interact with various elements in the portal via the UI. Examples of UI's include, without limitation, a graphical user interface (GUI) and web-based user interface.

Methods and systems of the present disclosure can be implemented by way of one or more algorithms. An algorithm can be implemented by way of software upon execution by the central processing unit 1105. For example, the algorithm may be configured to receive datasets or data streams, provide an AI-enabled simulation comprising the datasets or data streams and one or more domain-specific computing modules, generate future predictions based on the AI-enabled simulation, or a combination thereof.

### EXAMPLES

### Example 1—End-to-End Scalability Validation

In order to validate our scalability claims, a proof-of-concept of a grid of VMs was implemented. A small definition of VM in C language was compiled using a standard GCC for a multicore CPU, as well as for NVIDIA GPUs using CUDA compiler. Preliminary results showed that the overhead caused by the VM emulator was roughly 5-6×. In other words, a 600 MHz machine may be efficiently emulated on a 3 GHz CPU. Without any modifications, 100,000 instances of VMs were run on a single Volta GPU running at approximately 200 MHz each. This implementation can be extended to multiple heterogeneous nodes when the GPUs and CPUs use the same memory space.

### Example 2—End-to-End Correctness Demonstration

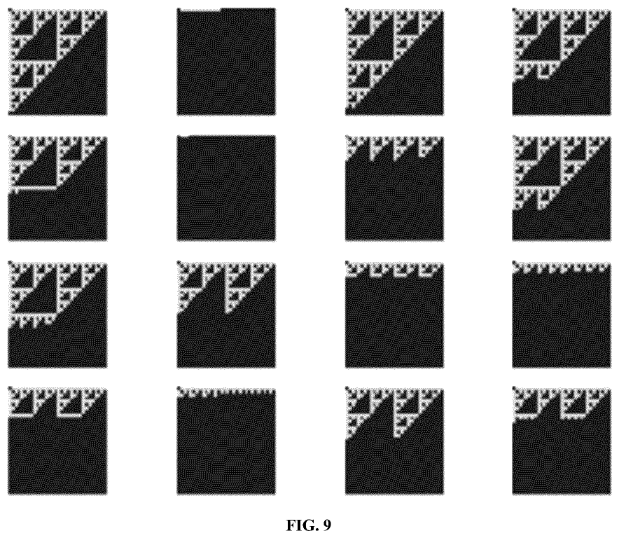

A small VM was implemented on old 8-bit CPU architectures, such as 6502 or Intel 8080. In order to validate that the engine was implemented correctly, a series of self-tests were run to test all combinations of instructions, perform memory and register moves, arithmetic operations, and a checksum was produced at the end. This procedure was run for billions of cycles, which made an implementation-related bug unlikely. A series of selected programs for a grid of VMs were then executed and the memory contents were inspected at the end. An example illustration of the memory contents are shown in FIG. 9, which illustrates memory contents of a grid of 16 VMs that were running an 18 byte long program generating a selected pattern. Note that all VMs operated asynchronously. This approach was also tested on an GPU implementation running 100,000 VMs at once. It was simple to dump the contents of all VMs and then compare to some reference output, which can allow for automation.

### Example 3—Heterogeneous Architecture Demonstration

As described in Example 1 and Example 2, a system of VMs were successfully tested on CPUs, GPUs, and various mixtures of both. Since the VMs were software-defined, it was clear that any Turing-complete machine may be implemented and emulated. In addition to the mainstream types of CPUs and NVIDIA GPUs, the same code as Example 2 was tested on embedded CPUs using nothing but ANSI C without system libraries, OpenCL for Intel CPUs and Intel/AMD GPUs.

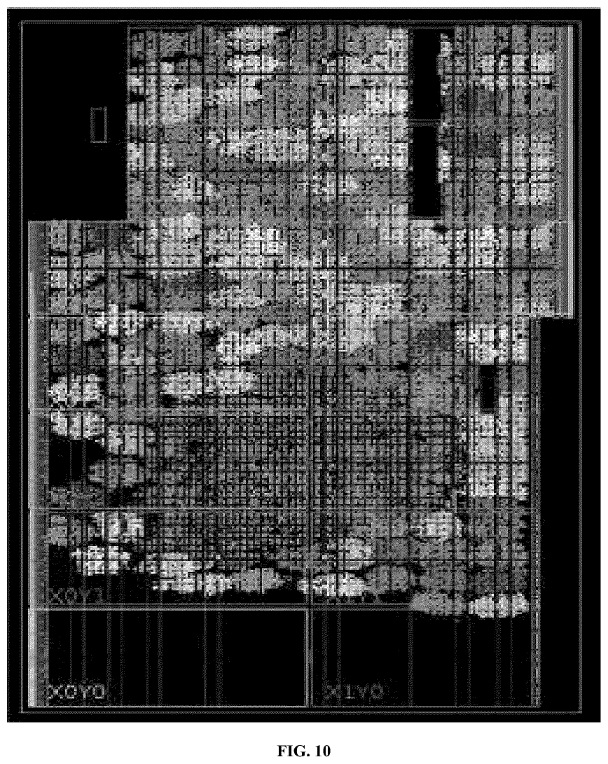

The performance of an FPGA implementation of such a VM were also evaluated. Approximately 1000 cores were fit in a medium sized Xilinx ZYNQ 7045 FPGA running at 600 MHz. After this VM layer was applied, all these different architectures can execute the same code, which made this approach very flexible. An FPGA floorplan illustrating how many VMs were placed in the programmable logic is illustrated in FIG. 10.

### Example 4—Scalability Test on a GPU Node

The scalability of a GPU node was tested by measuring the total performance as a instructions per second. This test showed the total number of VM cycles that can be executed. Each VM was a small 8-bit CPU with 4 kB of memory and was tested on RTX A6000. The results are shown in Table 2, where the performance is shown in million instructions per second.

TABLE 2

| | Total Performance |
|---|---|
| Number of VMS | (million instructions/sec) |
| 1 | 2 |
| 2 | 5 |
| 4 | 10 |
| 8 | 19 |
| 16 | 35 |
| 32 | 61 |
| 64 | 119 |
| 128 | 213 |
| 256 | 346 |
| 512 | 795 |
| 1024 | 1472 |
| 2048 | 2810 |
| 4096 | 4676 |
| 8192 | 5581 |
| 16384 | 6281 |

As shown, the performance scaled well with the number of VMs. The results also showed that >10,000 concurrent programs/cores can run at the same time.

### Certain Definitions

Unless otherwise defined, all technical terms used herein have the same meaning as commonly understood by one of ordinary skill in the art to which the present subject matter belongs.

As used in this specification and the appended claims, the singular forms “a,” “an,” and “the” include plural references unless the context clearly dictates otherwise. Any reference to “or” herein is intended to encompass “and/or” unless otherwise stated.

Reference throughout this specification to “some embodiments,” “further embodiments,” or “a particular embodiment,” means that a particular feature, structure, or characteristic described in connection with the embodiment is included in at least one embodiment. Thus, the appearances of the phrase “in some embodiments,” or “in further embodiments,” or “in a particular embodiment” in various places throughout this specification are not necessarily all referring to the same embodiment. Furthermore, the particular features, structures, or characteristics may be combined in any suitable manner in one or more embodiments.

The term “simulation intelligence” as referred to herein generally describes the merger of artificial intelligence/machine learning (AI/ML), simulation, and scientific computing. In some cases, simulation intelligence studies processes and systems in silico to better understand and discover in situ phenomena. In some instances, simulation intelligence serves as in silico testbeds for developing, experimenting, and/or testing AI/ML prior to in situ use. In some cases, simulation intelligence is enabled by a purpose-built operating system (e.g., Sim-AI OS, as described herein). In some cases, simulation is enabled by systems comprising capabilities such as automatic differentiation and/or machine programming.

While preferred embodiments of the present disclosure have been shown and described herein, it will be obvious to those skilled in the art that such embodiments are provided by way of example only. It is not intended that the present disclosure be limited by the specific examples provided within the specification. While the present disclosure has been described with reference to the aforementioned specification, the descriptions and illustrations of the embodiments herein are not meant to be construed in a limiting sense. Numerous variations, changes, and substitutions will now occur to those skilled in the art without departing from the present disclosure. Furthermore, it shall be understood that all aspects of the present disclosure are not limited to the specific depictions, configurations or relative proportions set forth herein which depend upon a variety of conditions and variables. It should be understood that various alternatives to the embodiments of the present disclosure described herein may be employed in practicing the present disclosure. It is therefore contemplated that the present disclosure shall also cover any such alternatives, modifications, variations or equivalents. It is intended that the following claims define the scope of the present disclosure and that methods and structures within the scope of these claims and their equivalents be covered thereby.

1.-21. (canceled)

22. A simulation intelligence (SI) system comprising:
one or more virtual machines (VMs) configured to generate a reconfigurable architecture for performing a simulation, wherein each of the one or more VMs comprises an abstraction of a computer engine, and wherein the reconfigurable architecture comprises:
one or more SI modules configured to automatically perform at least one of (i) multi-physics or multi-scale modeling, (ii) surrogate modeling and emulation, (iii) simulation-based inference, (iv) causal modeling and inference, or (v) agent-based modeling, and
one or more SI workflows configured to automatically determine a simulation framework of the one or more SI modules for performing the simulation; and
a compiler configured to compile software executed on the one or more VMs for performing the simulation, wherein the compiler is configured to or is capable of automatic differentiation (autodiff) and/or probabilistic programming.

23. The system of claim 22, wherein the one or more SI workflows comprises (i) inverse design, (ii) open-ended optimization, (iii) continual learning, (iv) causal inference and discovery, (v) simulator inversion, (vi) human machine inference or active science), (vii) uncertainty reasoning, (viii) counterfactual reasoning, (ix) digital twins, (x) multi-modal simulation, or (xi) physics-informed learning.

24. The system of claim 22, wherein performing the simulation comprises simulating at least one problem in physics, complexity, synthetic biology, chemistry, materials, medicine, systems biology, neurological or cognitive sciences, energy, manufacturing, transportation and infrastructure, agriculture, ecology, socioeconomics and markets, finance, geopolitics, defense, climate, earth systems, astrophysics, or cosmology.

25. The system of claim 22, wherein the one or more VMs comprises autodiff capabilities.

26. The system of claim 25, wherein the autodiff capabilities comprise emitting gradient programs at intermediate representations (IR) and/or at the instruction set.

27. The system of claim 22, wherein the one or more VMs are parameterized.

28. The system of claim 22, wherein the one or more VMs comprises one or more parameters to be optimized.

29. The system of claim 28, wherein the one or more parameters comprises a size of memory, number and/or width of registers, available instruction set, instruction encoding, implementation of firmware, input/output (I/O), or any combination thereof.

30. The system of claim 22, wherein the compiler comprises a multi-level intermediate representation (MLIR) compiler or a low-level intermediate representation (LLVM IR) compiler.

31. The system of claim 22, wherein the autodiff comprises converting a programming language into machine code processed on heterogeneous hardware.

32. The system of claim 22, wherein the compiler enables the use of probabilistic programming, domain specific languages, differentiable programming, or any combination thereof.

33. The system of claim 22, wherein the one or more VMs run on a graphics processing unit (GPU), a central processing unit (CPU), a field programmable gate array (FPGA), an application-specific integrated circuit (ASIC), a non-volatile memory express (NVMe), a microcontroller, an artificial intelligence (AI)-accelerator, or any combination thereof.

34. The system of claim 33, wherein the AI-accelerator comprise Google-TPU®, Graphcore®, Cerebras®, SambaNova®, or a combination thereof.

35. The system of claim 22, wherein about 1000 VMs run on a GPU.

36. The system of claim 22, wherein about 10,000 VMs run on a GPU.

37. The system of claim 22, wherein about 500 VMs run on a CPU.

38. The system of claim 22, wherein the system allows for machine programming across a stack.

39. The system of claim 22, wherein the system further comprises a software stack, a hardware stack, or a hardware-software stack.

40. The system of claim 39, wherein the software stack, the hardware stack, the hardware-software-stack, or any combination thereof, is differentiable.

41. The system of claim 39, wherein the software stack, the hardware stack, the hardware-software stack, or any combination thereof, enables gradient-based learning and/or optimization.
